(19) United States
(12) Patent Application Publication
(10) Pub. No.: US 2013/0166367 A1
(43) Pub. Date: Jun. 27, 2013

(54) SYSTEMS AND METHODS FOR ADMINISTERING MERCHANT REWARDS TO PURCHASERS WHO INCREASE SPENDING AT PARTICIPATING MERCHANTS

(71) Applicants: Scott Stouffer, North Potomic, MD (US); Bruce Olson, Vienna, VA (US); Luigi Canali, North Potomac, MD (US); Anil Mamidi, Ashburn, VA (US); Madhu Koneni, Ashburn, VA (US)

(72) Inventors: Scott Stouffer, North Potomic, MD (US); Bruce Olson, Vienna, VA (US); Luigi Canali, North Potomac, MD (US); Anil Mamidi, Ashburn, VA (US); Madhu Koneni, Ashburn, VA (US)

(21) Appl. No.: 13/668,141

(22) Filed: Nov. 2, 2012

Related U.S. Application Data
(60) Provisional application No. 61/578,780, filed on Dec. 21, 2011.

(51) Int. Cl. G06Q 30/02

(52) U.S. Cl. 705/14.25; 705/14.27; 705/14.26

(57) ABSTRACT

The disclosure relates to, among other things, systems, methods, and computer-readable media for rewarding a purchaser for increasing their purchase volume with at least one participating merchant. Embodiments may comprise offering an incentive for the purchaser to increase their purchase volume with the participating merchant. Embodiments may further comprise obtaining a first set of electronic transactions between the purchaser and the participating merchant. Embodiments may further comprise determining a merchant baseline for the purchaser based on the first set of electronic transactions. Embodiments may further comprise obtaining a second set of electronic transactions between the purchaser and the participating merchant. Embodiments may further comprise comparing the second set of electronic transactions to the merchant baseline. Embodiments may further comprise providing the reward to the purchaser based on the comparison.

### RELATED APPLICATIONS

The present application claims priority to U.S. Provisional Application No. 61/578,780 (filed on Dec. 21, 2011) and U.S. Provisional Application No. 61/356,070 (filed on Nov. 4, 2011), the entirety of each incorporated herein by reference.

### TECHNICAL FIELD

The present disclosure relates generally to systems and methods for providing merchant rewards to customers.

### BACKGROUND

Present rewards systems, such as Groupon™, provide offers to users to purchase discounted services or goods. These systems, however, may result in losses at participating merchants due to the number of current customers who purchase these deals without an increase in the amount of business they conduct with the participating merchant.

Accordingly, systems and methods for rewarding customers based on an increase in their purchase volume are needed.

### SUMMARY

Among other things, systems and methods for rewarding customers based on an increase in their purchase volume are disclosed herein.

In one embodiment, a computer-implemented method for rewarding a purchaser for increasing their purchase volume with at least one participating merchant is disclosed. The method may comprise offering an incentive for the purchaser to increase their purchase volume with the participating merchant. The method may further comprise obtaining a first set of electronic transactions between the purchaser and the participating merchant. The method may further comprise determining a merchant baseline for the purchaser based on the first set of electronic transactions. The method may further comprise obtaining a second set of electronic transactions between the purchaser and the participating merchant. The method may further comprise comparing the second set of electronic transactions to the merchant baseline. The method may further comprise providing the reward to the purchaser based on the comparison.

In another embodiment, a system for rewarding a purchaser for increasing their purchase volume with at least one participating merchant is disclosed. The system may comprise a storage medium storing a set of instructions. The system may further comprise at least one processor for executing the set of instructions to perform the method of paragraph [006]. In another embodiment, a non-transitory computer-readable medium storing a set of instructions is disclosed, which when executed by a processor, performs a method of paragraph [006].

### BRIEF DESCRIPTION OF THE DRAWINGS

FIG. 1a is a drawing of a top-level environment consistent with an embodiment.

FIG. 1b is a drawing of a Purchase Transaction Data System consistent with an embodiment.

FIG. 2 is an overall process flow diagram consistent with an embodiment.

FIG. 3 is a detailed process flow diagram depicting a method for connecting users' transaction accounts to the system consistent with an embodiment.

FIG. 4 is a detailed process flow diagram depicting a method for acquiring historical transactions from users' connected transaction accounts consistent with an embodiment.

FIGS. 5a-5c depict a detailed process flow for a method for assigning commerce categories to user transactions consistent with an embodiment.

FIG. 6 is a detailed process flow depicting a method for calculating historical category spending baselines consistent with an embodiment.

FIG. 7 is a detailed process flow depicting a method for calculating historical merchant spending baselines consistent with an embodiment.

FIG. 8 is a detailed process flow depicting a method for identifying errors in historical transactional data and adjusting spending baselines to account for such errors consistent with an embodiment.

FIG. 9 is a detailed process flow depicting an alternate method for identifying errors in historical transactional data and adjusting spending baselines to account for such errors consistent with an embodiment.

FIGS. 10a-c depict a detailed process flow for a method for processing transactions to calculate user rewards and merchant rebates consistent with an embodiment.

FIGS. 11a-11c depict a detailed process flow depicting an alternate method for processing transactions to calculate user rewards and merchant rebates consistent with an embodiment.

FIGS. 12a-b depict a detailed process flow depicting a method for detecting and preventing gaming consistent with an embodiment.

FIGS. 13a-13b depict a detailed process flow for an alternate method for detecting and preventing gaming consistent with an embodiment.

FIG. 14 depicts a set of user related tables consistent with an embodiment.

FIG. 15 depicts a set of merchant and transaction related tables consistent with an embodiment.

### DETAILED DESCRIPTION OF EXEMPLARY EMBODIMENTS

The embodiments discussed below are merely exemplary. While the figures may depict particular sequences of steps, these steps may be practiced in any order, and certain steps may be omitted, without deviating from the scope of the embodiment. The embodiments may also be practiced by one or more computing devices. For example, one or more elements of an embodiment may be performed by a first computing device while other elements are performed by a second computing device. Additionally, the embodiments may be practiced by one or more instructions that are stored in a computer-readable medium.

The computing devices may include devices such as a client, a server (e.g., a web server), a personal computer, a mobile device, or any device that includes a processor and a memory. These computing devices may communicate over a network (e.g., a LAN, a WAN, or the Internet). Communicating over the network may allow the different elements of the embodiments below to be performed by different computing devices.

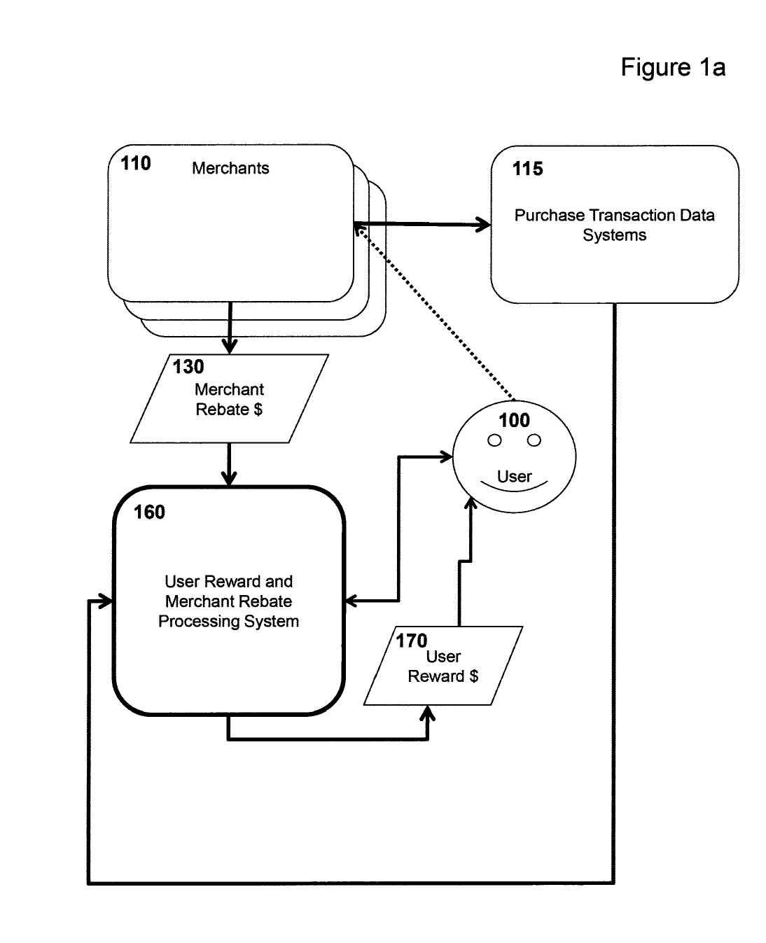

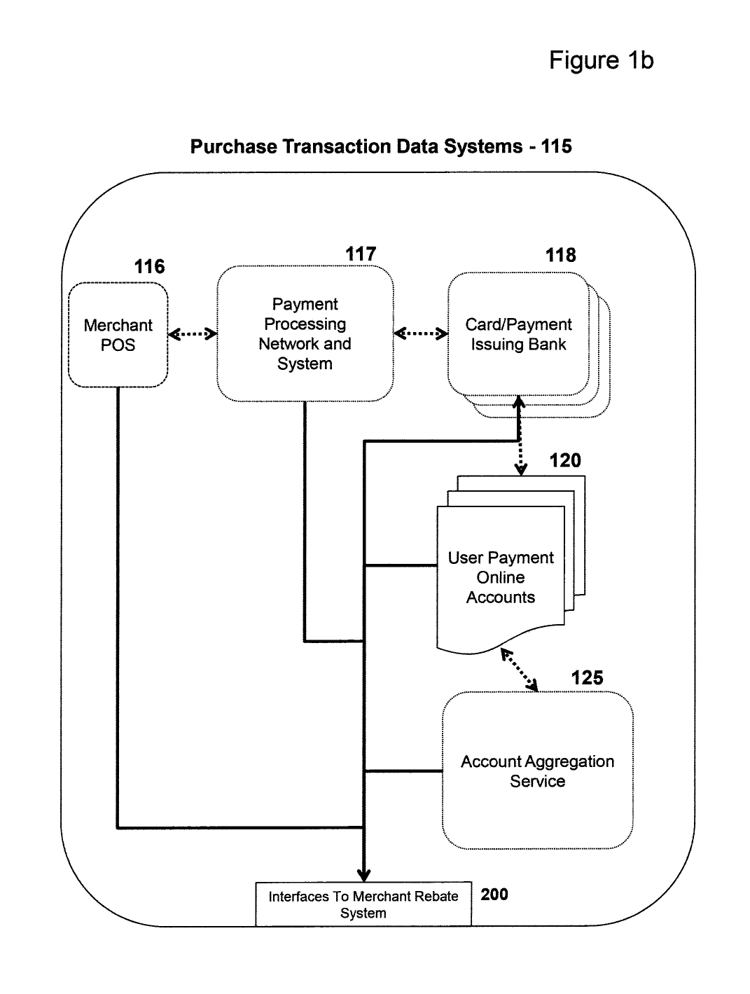

FIGS. 1a & 1b: Top-Level Environment

FIG. 1a depicts an exemplary top-level environment within which the system for administering merchant rebates may operate. In the ordinary course of business, a purchaser (e.g., a user) 100 may affect a purchase with a merchant 110 by submitting a debit card, credit card, or other electronic payment vehicle (e.g., PayPal™, Google Wallet™, etc.) to the merchant 110 who may process the payment through Purchase Transaction Data Systems 115.

By registering an account with the System 160, the purchaser 100 may subscribe to a service (“Service”) provided by the System 160 and may authorize the Service to act as an agent of the Purchaser 100 in order to access copies of the Purchaser 100's transactions through one or more elements of the Purchase Transaction Data Systems 115. The System 160 may analyze such transactions and may generate rewards 170 for the benefit of the Purchaser 100 for any transactions that meet certain qualifying conditions. These user rewards may be funded by merchant rebates 130 which are collected from participating merchants (“Merchant Partners”) upon the processing of qualifying transactions by the System 160.

System 160 may have applications in business-to-consumer, business-to-business, and business-to-government environments so long as the goods or services being purchased by the purchasing entity are typically paid for using debit cards, credit cards or other electronic payment methods (e.g., Google Wallet™, PayPal™, etc.).

FIG. 1b is a drawing of exemplary Purchase Transaction Data Systems 115. These systems may include components such as the merchant point-of-sale (POS) 116, payment processors and card association networks 117, card or payment account issuers 118, user payment online accounts 120 as well as account aggregation services 125. The System 160 may access purchase transaction data by interfacing with any or all of the elements via software application programming interfaces (API). The System may be completely decoupled from and independent of the Merchant POS 116 and Payment Processing Network and System 117 by accessing the transaction data via User Payment Online Accounts 120 or via Account Aggregation Services 125.

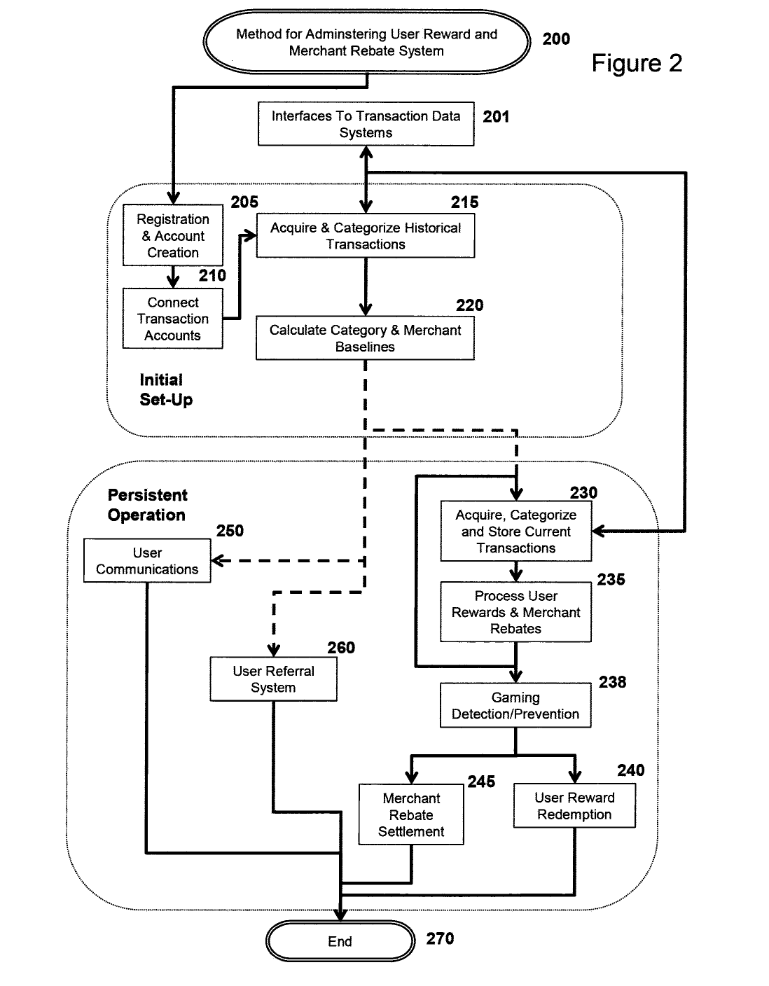

FIG. 2: Exemplary Overall Process Flow

FIG. 2a depicts an exemplary method 200 for providing and administering a user reward and merchant rebate system 160 as depicted in FIG. 1. This process may apply to each purchaser 100 who registers for the Service provided by the System 160. The System 160 may generally be considered to have a set of processes specific to the initial account set-up of any given purchaser, as well as a set of processes that operate persistently following the initial account set-up.

In step 205 a purchaser 100 may access a software application associated with the System 160 to determine if the Service provided by the System is available in the purchaser 100's location. This determination may be made by any number of methods including but not limited to allowing the purchaser 100 to enter their ZIP code (or alternative geographic unit) or interpreting the purchaser 100's location from their IP address. Access to this software application may include any number of methods such as via the Internet using a web browser, as well as via an application residing on a mobile communications device. If the Service is available, the System 160 may identify, to the purchaser 100, a set of Merchant Partners that are available to that purchaser 100 based on that purchaser 100's location.

As part of the registration process in step 205, the purchaser 100 may create a unique account with the System 160. To establish the unique account, the purchaser 100 may provide a valid email address and password that are stored in the User Registration Tables 2000. Alternatively, the System 160 may allow the purchaser 100 to establish the unique account based on that purchaser 100's unique account for some other service, for example a Facebook™ account or an online banking account. Additionally, the set of Merchant Partners that are available to that purchaser 100 may be stored in the User Merchant Table 2200.

A purchaser 100 may initially access the System 160 website via one of a variety of URLs and web landing pages depending on the venue through which the purchaser 100 was exposed to the program. For example, if the purchaser 100 was referred to the program from an existing registered purchaser 100 of the program, purchaser 100 may be provided one URL that references the referring user. If, on the other hand, the purchaser 100 was referred to the program by a particular Merchant Partner, that purchaser 100 may be provided with a different URL pointing to a landing page associated with that Merchant Partner. The System 160 may identify that purchaser 100 with the referring party and upon completing registration and account creation, a referral ID associated with the referring party may be stored in the User Registration Table 2000.

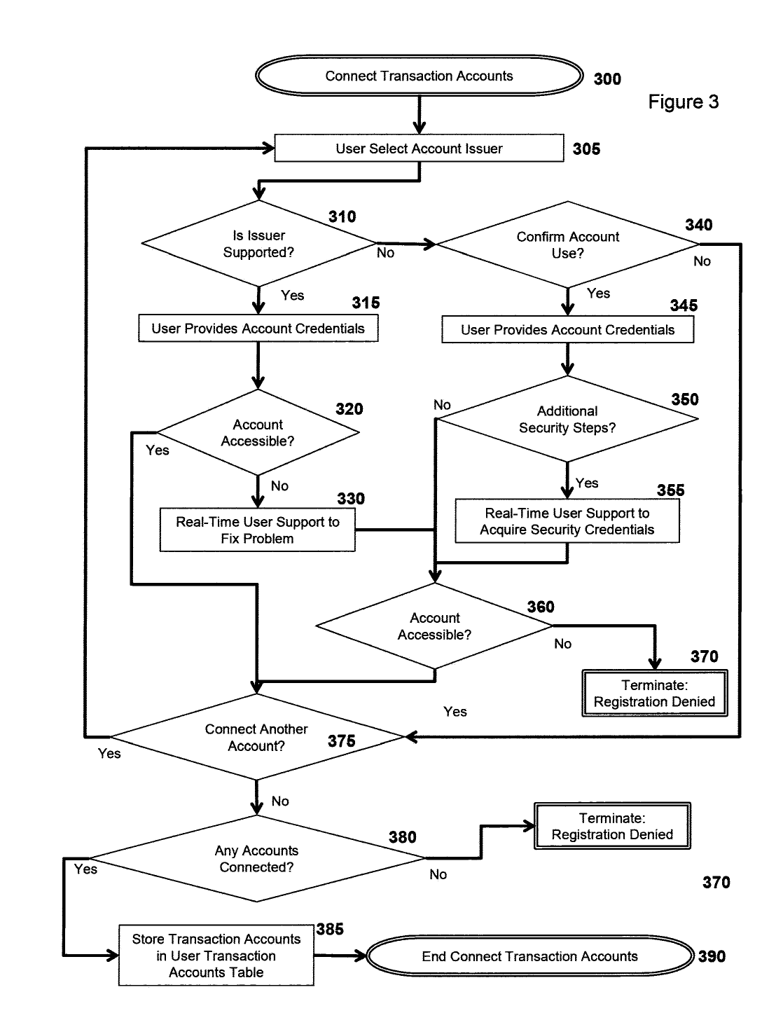

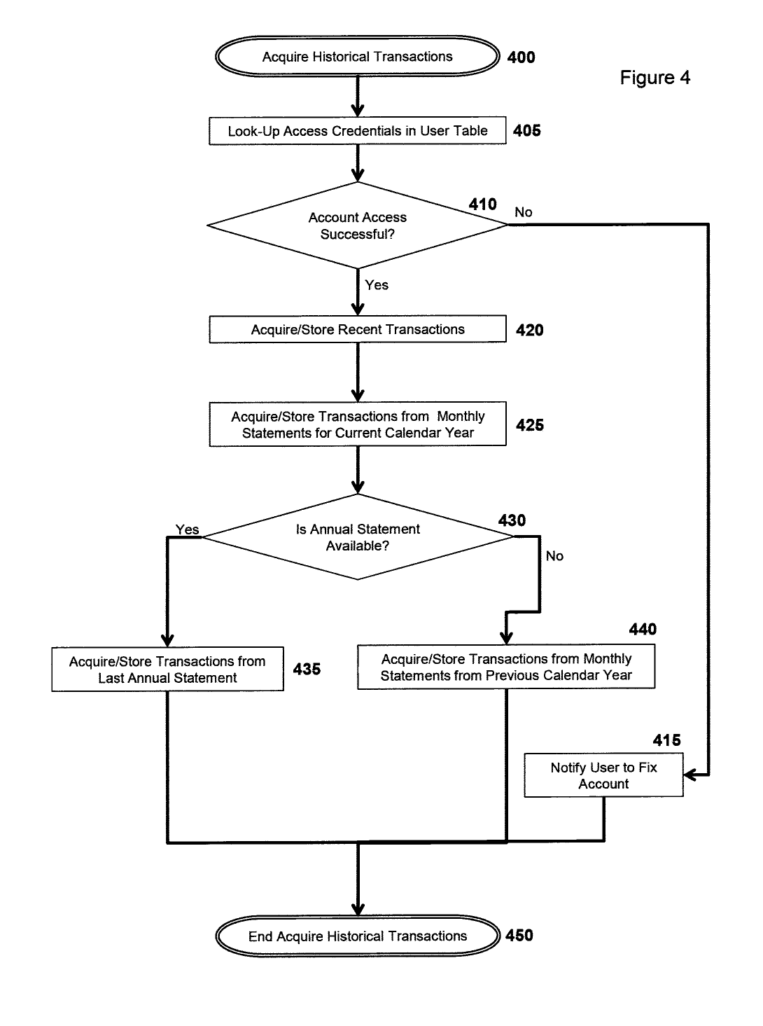

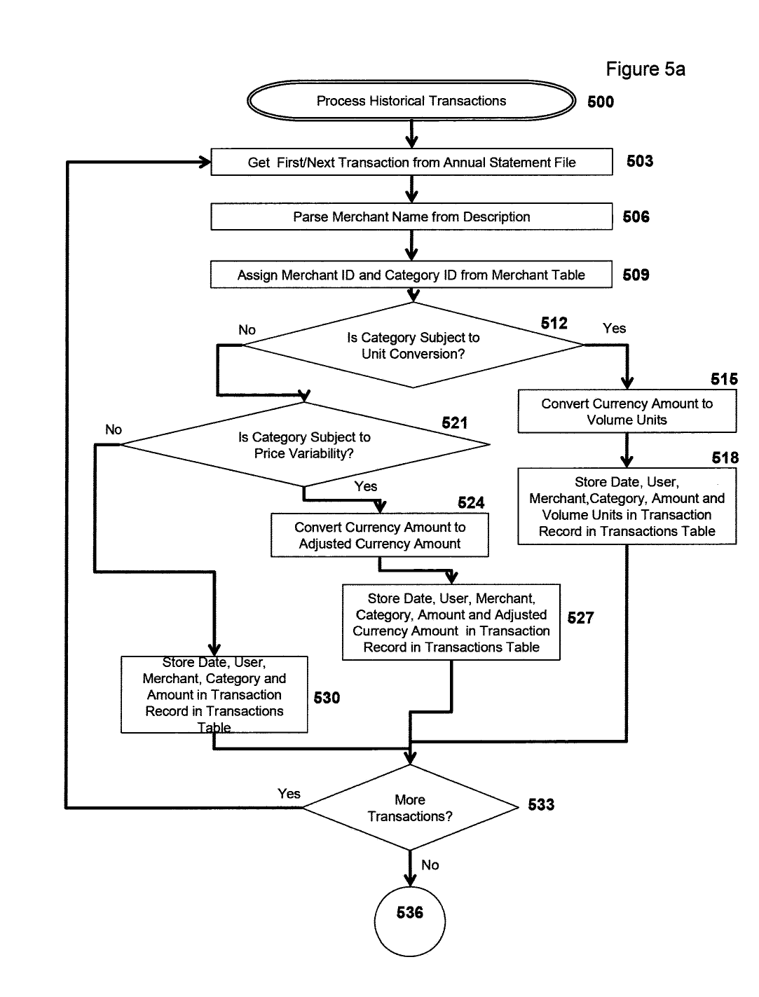

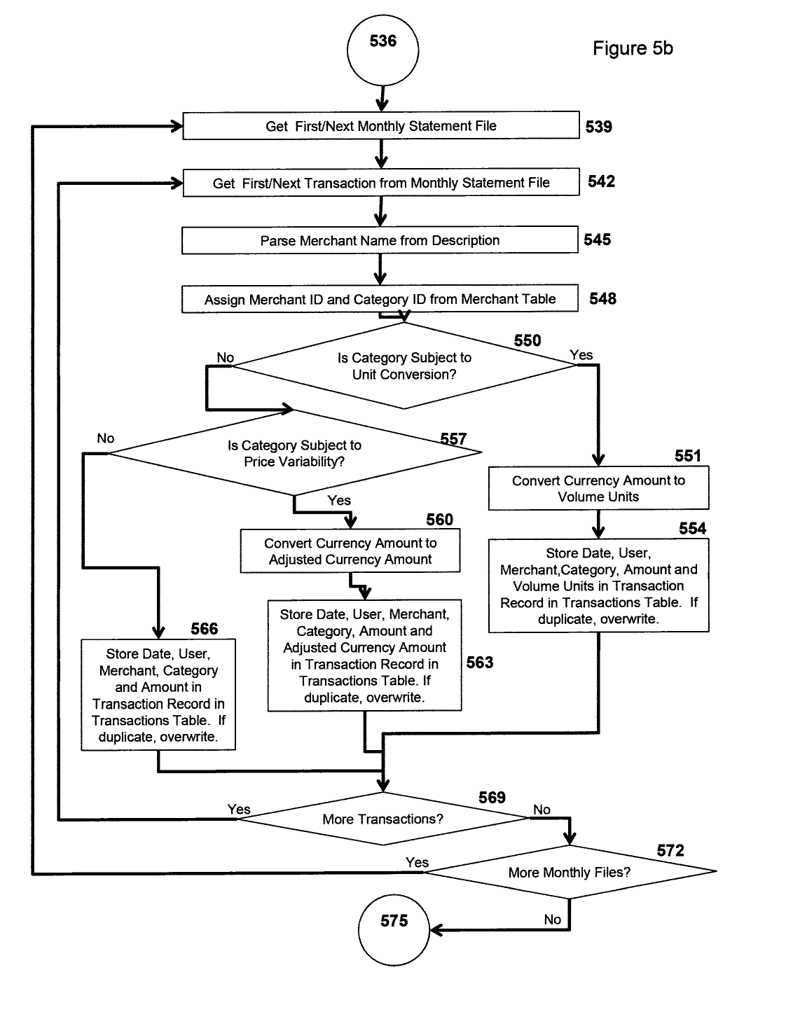

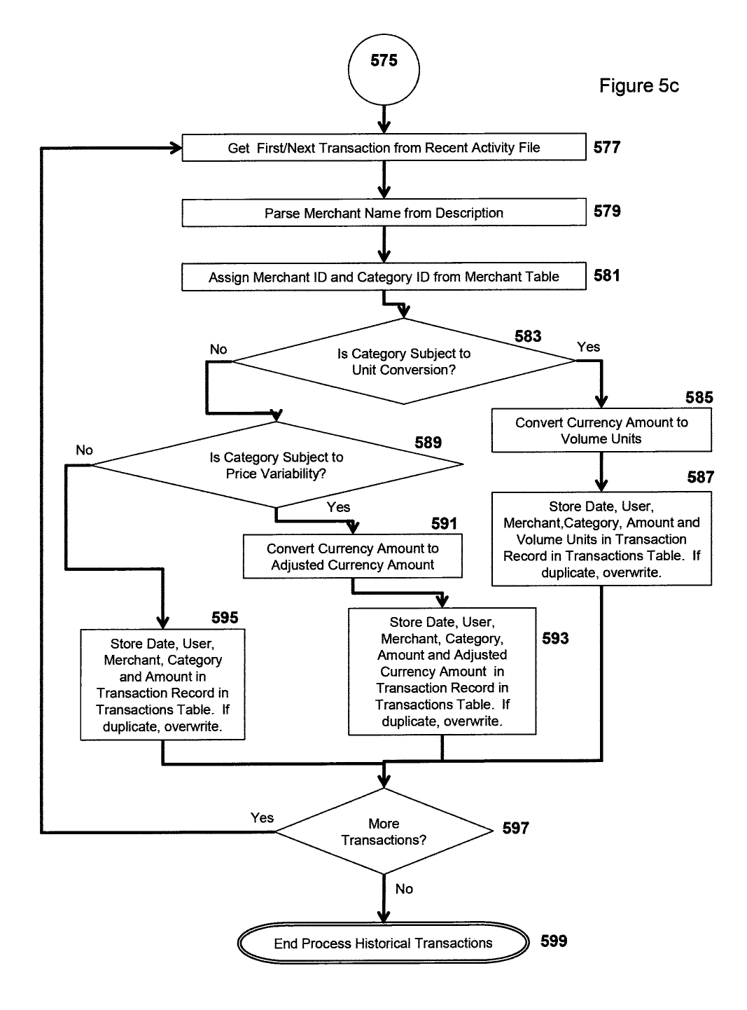

Following registration and account creation, a purchaser 100 may authorize the System 160 to acquire the purchaser 100's purchase transactions from one or more elements of the Purchase Transaction Data Systems 115. In one embodiment, the purchaser 100 may connect their payment online accounts (“Transaction Accounts”) 120 to the Service in step 210 as explained in more detail in FIG. 3. Once the purchaser 100 has successfully connected all relevant Transaction Accounts to the Service, the System 160 may access those Transaction Accounts in step 215 via software interfaces 201 and may acquire and categorize all transactions that occurred during some defined period prior to the date the purchaser 100 registered for the Service. Select embodiments of these processes are explained in detail in FIGS. 4 and 5a-5c.

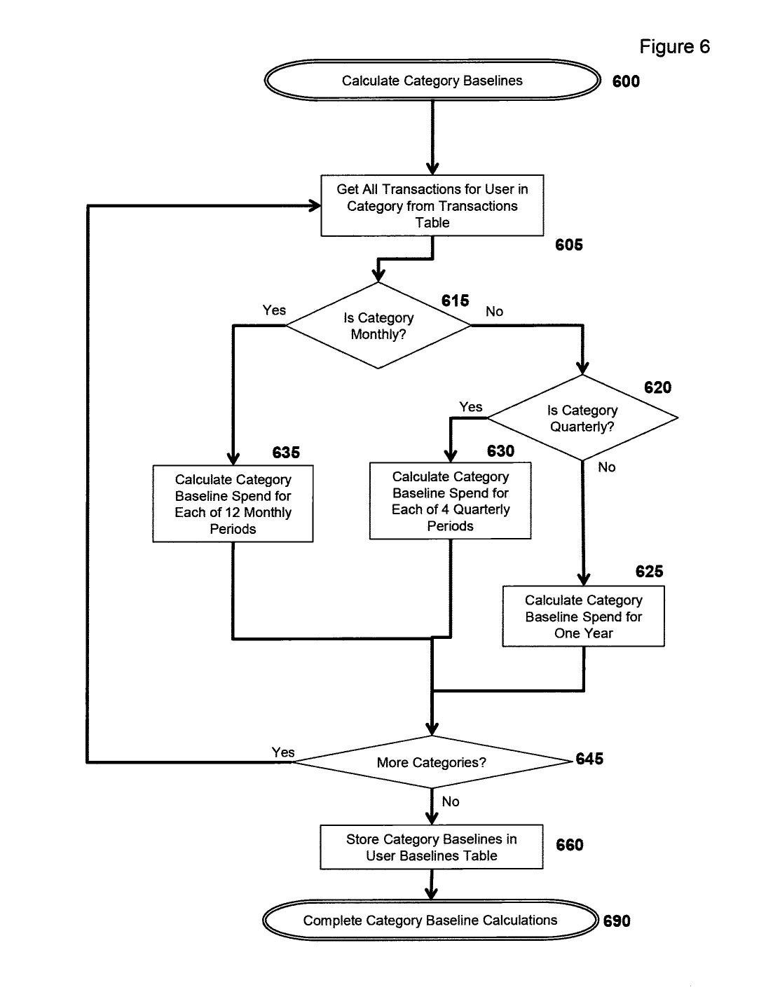

Once the historical transactions have been acquired and categorized, the System 160 may proceed to step 220 where it calculates baselines for specific commerce categories (e.g., groceries) as well as all Merchant Partners available to purchaser 100. Category baselines may represent the average spending levels in a particular commerce category (e.g., groceries, gasoline, etc.) by purchaser 100 during specific periods preceding the date the purchaser 100 registered for the Service. Merchant Partner baselines may represent the average spending levels with specific Merchant Partners by a purchaser 100 during specific periods preceding the date the purchaser 100 registered for the Service. This is explained in detail in FIGS. 6, 7 and 8.

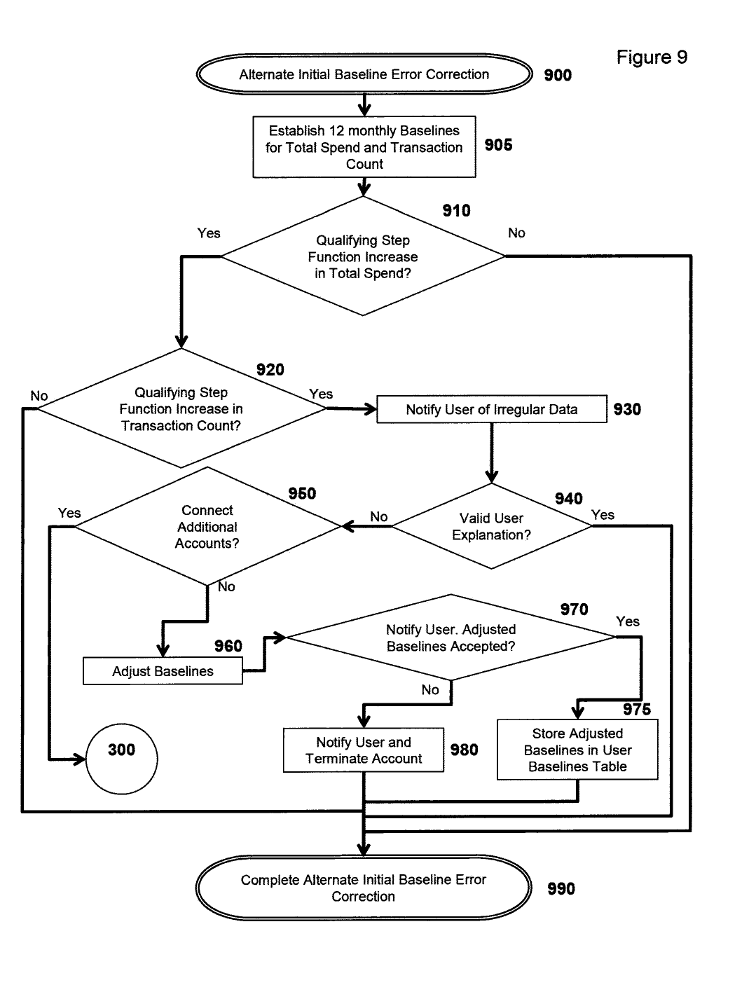

Following step 220, the initial set-up for a purchaser 100 may be deemed complete and the System 160 may enter a state of persistent operation for that purchaser 100. During persistent operation, the System 160 may periodically acquire current (e.g., on-going) transactions via software interfaces 201 from the purchaser 100's Transaction Accounts and may categorize those transactions in step 230. This process may be essentially identical to the process used in step 215 although limited only to the purchaser 100's most recent transactions. These transactions may be stored in the Transactions Table 3000 in step 230. Then, in step 235, the System 160 may process user rewards and merchant rebates for the transactions acquired in step 230. One embodiment of this process is explained in more detail in FIG. 9. Steps 230 and 235 may be repeated on a regular basis for each registered purchaser 100, either as scheduled by the System 160 or on-demand if a purchaser 100 logs on to the System 160. For ease of reading, steps 230 and 235 are shown separately, but may be performed in a single step. One embodiment may combine those steps so that each current transaction is acquired, categorized, and processed for rewards and rebates before acquiring the next current transaction.

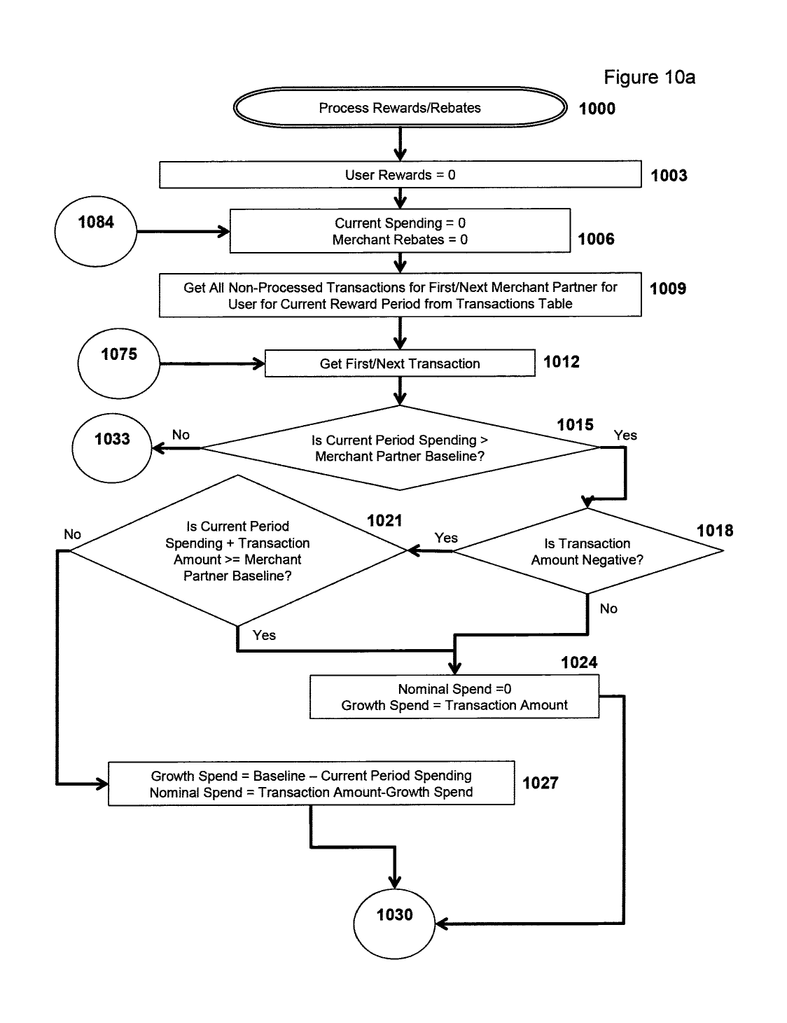

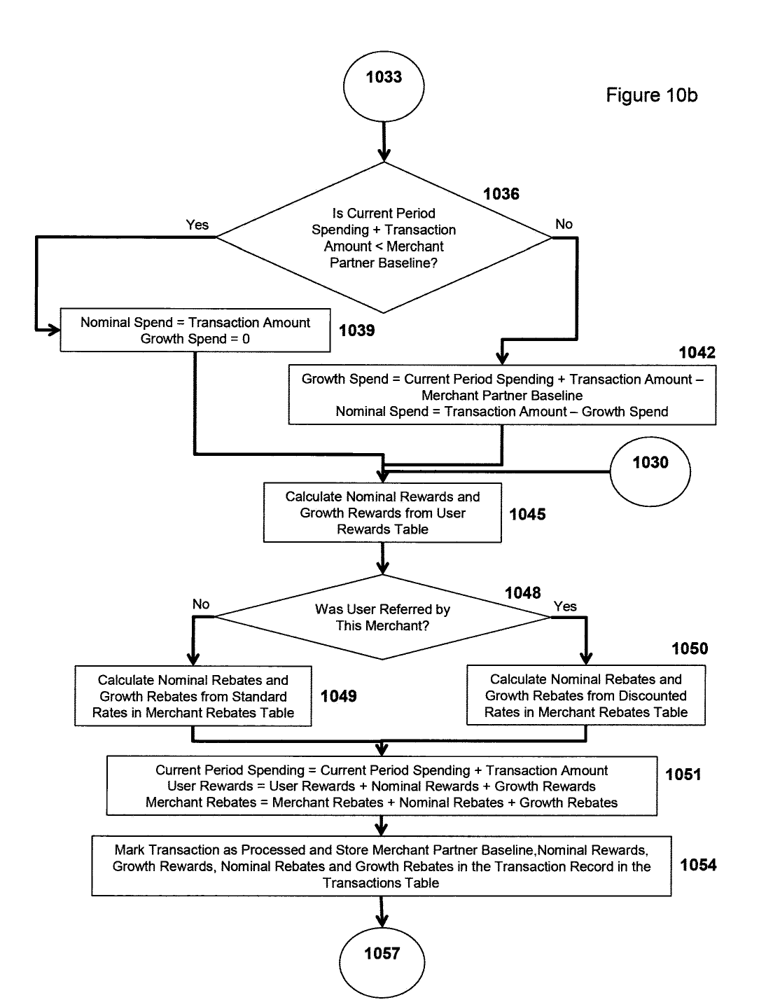

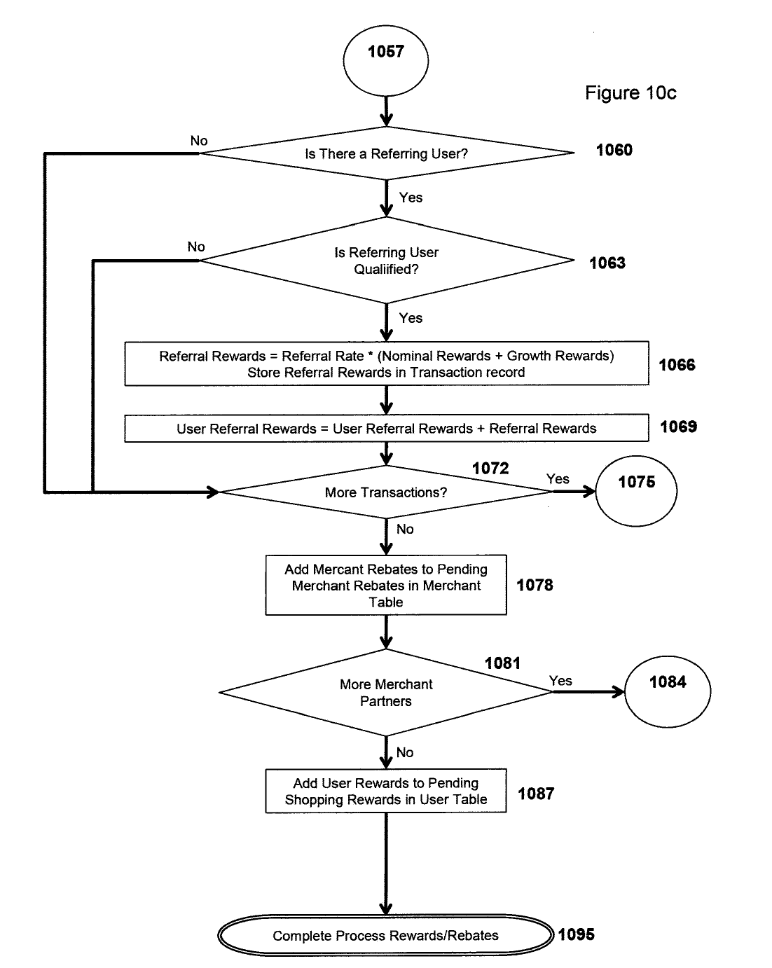

In step 238, the System 160 may periodically compare a purchaser 100's spending patterns since the time they registered with the Service to their historical spending patterns prior to registering for the Service. If the System 160 detects an irregularity between those spending patterns that are indicative of gaming, the System 160 may either adjust the purchaser 100's baselines or terminate the purchaser 100 from the Service. An example of this process is explained in detail in FIG. 10.

In step 240, the System 160 may initiate a process to redeem rewards to purchaser 100 either once purchaser 100 has accumulated some predetermined amount of rewards or on some regularly scheduled basis. The System 160 may use any number of methods to redeem rewards, including but not limited to issuing paper checks, direct deposits to purchaser 100's bank accounts or credits to purchaser 100's online payment accounts (e.g., PayPal™, etc.).

In step 245 the System 160 may issue invoices to Merchant Partners for accumulated rebates owed. Upon receiving payment, the System 100 may recognize outstanding pending rebates as paid.

The System 160 may also include a variety of methods as indicated in step 250 for communicating with purchaser 100 so that purchaser 100 can monitor their spending patterns, monitor their rewards activity and be notified of any relevant alerts or offers.

The System 160 may also include a method for allowing purchaser 100 to refer other users to the Service as indicated in step 260.

FIG. 3: Exemplary Connection of Transaction Accounts

Following registration and account creation, in one embodiment, a purchaser 100 connects their Transaction Accounts 120 to the Service. An example of this process is explained in detail as depicted by process 300 in FIG. 3. The purchaser 100 may be instructed to connect the Transaction Accounts for all credit cards, debit cards, and electronic payment accounts they have actively used prior to registering for the Service as well as any such accounts they expect to actively use going forward. The purchaser 100 may be further instructed that they must have established online accounts for each of the transaction accounts they desire to connect and if they don't have those established to first go to their account issuer's (“Issuer”) website and set-up the online accounts.

Beginning with step 305, the purchaser 100 may be prompted to select the Issuer for the Transaction Account they desire to connect. The purchaser 100 may select the Issuer from a pre-populated list provided by the System 160 or if the Issuer does not appear on the list, the purchaser 100 may either enter the URL for the login page of the Transaction Account or the Issuer name that they wish to connect to the Service.

In one embodiment, the System 160 software may be configured to access the online account of each individual Issuer. With thousands of Issuers in existence at any time, it is expected that the System 160 may not be configured to access the online accounts at certain Issuers at the time that a purchaser 100 attempts to connect a Transaction Account to the Service. The process to connect Transaction Accounts 300 uniquely includes a number of steps including confirmation of account usage (step 340) and real-time engagement with helpdesk agents (steps 330 and 355) in order to minimize the number of users who are unable to complete the process and therefore unable to enjoy the benefits of the Service. An alternative embodiment may allow the System 160 to integrate with third-party software services that provide the access to the Transaction Accounts, for example account aggregation services 125 such as those provided by Yodlee™, Intuit™, and CashEdge™.

Following the purchaser 100's selection of the Issuer, the System 100 may verify if the selected Issuer is supported by the System 160 in step 310.

If the selected Issuer is identified as supported in step 310, the purchaser 100 may then be prompted in step 315 to enter the access credentials to the Transaction Account for that Issuer. These credentials may include a username, password, PIN, and answers to a variety of security questions. The System 160 may then attempt to connect to the Transaction Account in step 320. If the Transaction Account is accessible by the System 160 the Transaction Account connection may be deemed complete for that account and the process proceeds to step 375. If the Transaction Account is not accessible by the System 160 in step 320, the purchaser 100 may be connected in step 330 to a live helpdesk agent in order to resolve any issues that may be preventing the System 160 from accessing the Transaction Account. If the issues preventing access are resolved in step 330 and the Transaction Account may be accessed in step 360, the Transaction Account connection may be deemed complete for that account and the System 160 may proceed to step 375. If the issues preventing access are not resolved in step 330 and therefore the Transaction Account cannot be accessed in step 360, the process to connect Transaction Accounts 300 may be terminated and purchaser 100 may be denied registration in step 370.

If the selected Issuer is identified as un-supported in step 310, the purchaser 100 may be prompted in step 340 to confirm that the account associated with that Issuer has been actively used prior to registering for the Service or is likely to be actively used going forward. If the purchaser 100 responds that the account has not been actively used and is unlikely to be actively used, the account may be declared irrelevant and the process may proceed to step 375. If purchaser 100 responds that the account either has been actively used prior to registering for the Service or is anticipated to be actively used going forward, the purchaser 100 may enter the credentials for the Transaction Account in step 345. This may include a URL, username, password, PIN, or other information required by the Issuer. The System 160 may then attempt to connect to the Transaction Account. If the System 160 determines in step 350 that no additional security steps are required and that it has full access to the Transaction Account in step 360, the Transaction Account connection may be deemed complete for that account and the process may proceed to step 375. If the System 160 determines in step 350 that additional security steps are required, purchaser 100 may be connected in step 355 to a live helpdesk agent in order to capture the necessary information to fulfill the additional security steps. Following that, if the Transaction Account can be fully accessed in step 360, the Transaction Account connection may be deemed complete for that account and the process proceeds to step 375. If the Transaction Account cannot be fully accessed in step 360, the process to connect Transaction Accounts 300 may be terminated and purchaser 100 may be denied registration.

If the purchaser 100 indicates in step 375 a desire to connect more Transaction Accounts the process may begin again starting at step 305. If the purchaser 100 does not desire to connect additional Transaction Accounts as determined in step 375, and at least one Transaction Account has been connected to the Service as determined in step 380, the account credentials for each connected Transaction Account may be stored in the Transaction Accounts Table 2300 in step 385 and the process for connecting Transaction Accounts 300 may be complete as depicted by step 390. If the purchaser 100 does not desire to connect additional Transaction Accounts as determined in step 375, and no Transaction Accounts have been connected to the Service as determined in step 380, the process to connect Transaction Accounts 300 may be terminated and purchaser 100 may be denied registration in step 370.

FIG. 4: Exemplary Acquisition of Historical Transactions

Following the successful completion of connecting a Transaction Account using the process to connect Transaction Accounts 300, the System 160 may begin the process of acquiring historical transactions 400 for that Transaction Account as depicted in one embodiment in FIG. 4. The System 160 may get the access credentials for the Transaction Account from the Transaction Accounts Table 2300. The System 160 may then attempt to access the Transaction Account in step 410.

If the System 160 is unable to access the Transaction Account in step 410, purchaser 100 may be notified in step 415 to fix the account, which may involve updating the access credentials for that account. The current attempt to acquire historical transactions for that Transaction Account may be terminated in step 450 pending purchaser 100 having fixed the account. The System 160 may then attempt again to acquire historical transactions for that Transaction Account at a later date.

If the System 160 may be able to access the Transaction Account in step 410, the System 160 may proceed to download all transactions for some predefined period of time prior to the date that purchaser 100 established an account with the Service. The exemplary embodiment depicted in FIG. 4 uses twelve months as that period. To ensure that twelve months of transactions are downloaded, the System 160 may first directly connect to an OFX server (or equivalent) if one is supported by the Issuer and downloads all available transactions in step 420 from the OFX server (or equivalent). If the Issuer does not support an OFX server (or equivalent), the System 160 may use a web connection to the Transaction Account and downloads in step 420 all recent transactions available. These transactions may then be stored in a temporary file for recent transactions. Next, using the web connection, the System 160 may download, in step 425, each of the monthly statements available for the current calendar year. These statements may be presented in a variety of file types and the System 160 may use all necessary techniques to convert the statement files to machine-readable formats after which the System 160 may extract the transactions from the converted data. These transactions may be stored in temporary files corresponding to each monthly statement. Next, in step 430 the System 160 may check to see if an annual statement is available for the prior year. If an annual statement is available, the System 160 may use a web connection to download in step 435 the annual statement for the previous calendar year. Similar to monthly statements, the annual statements may be converted to machine-readable formats and the transactions may be extracted and stored in a temporary file corresponding to the annual statement. If annual statements are not available, the System 160 may proceed to download additional monthly statements from the prior calendar year in step 440 until the System 160 has downloaded the necessary number of monthly statements to sufficiently analyze the purchaser 100's purchase history. These statements may be converted and the transactions extracted and stored in temporary files corresponding to the monthly statements. The process for acquiring historical transactions for a given account 400 may be completed as depicted in step 450.

FIG. 5: Exemplary Processing of Historical Transactions

Following the process to acquire historical transactions 400, each file stored in process 400 may be processed in order to assign each transaction to the relevant purchaser 100, a specific merchant and a specific commerce category (e.g., gasoline, groceries, etc.) using the process for processing historical transactions 500 (e.g., as depicted in FIG. 5). In step 503, the System 160 may get the first transaction from the annual statement file created in process 400 and then identify the merchant name from the transaction description using any number of parsing techniques in step 506. The merchant name may then be searched in the Merchant Table 4000 looking for a match in step 509. If a match is found the transaction may be assigned to a merchant and a category ID may be identified as indicated in the Merchant Table. The Merchant Table may be populated from any commercially available database that lists merchants along with associated codes that indicate the type of business (e.g., SIC codes). Alternatively, the Merchant Table may be populated manually. The System 160 may accommodate merchants whose businesses span multiple merchandise categories such as mass-merchandisers or warehouse clubs. The System 160 may maintain a table of these merchants and may designate them as Special Merchants. Special Merchant transactions may be proportionately split into multiple category specific transactions using any number of methods that may include the use of predetermined proportional allocations as derived from publicly available information from those merchants. An alternative method of splitting Special Merchant transactions may be to allow purchaser 100 to allocate Special Merchant transactions against specific commerce categories.

In certain embodiments, it may be preferable to treat certain commerce categories on a unit volume basis rather than a currency basis. In one example, the commerce category may be gasoline, where rewarding purchasers 100 based on the number of gallons of gasoline they purchase rather than the dollar amount of gasoline they purchase may be preferred. Other examples where unit volume may be preferable to currency (e.g., dollar) volume may include any number of commodities, including grain (e.g., bushels of corn, wheat etc.), precious metals (e.g., silver, gold) or building materials (e.g., copper wiring). If the System 160 determines in step 512 that a transaction is subject to unit conversion, the System 160 may proceed to convert that transaction in step 515 from a base currency amount (e.g., dollars) to an equivalent volume amount measured in some other units (e.g., gallons) by dividing the transaction base currency amount by some conversion index relevant to the transaction date. One transaction category that is subject to unit conversion may be gasoline purchases. In this case, a conversion technique (e.g., step 515) may use historical price per gallon data as regularly published by reputable government or industry statistical analysis entities to eliminate the variability in spending caused by the variability (e.g., inflation/deflation) in the price of gasoline. Following the currency-to-volume conversion, the System 160 may store in step 518 the transaction date, user ID, merchant ID, category ID, base currency amount and volume equivalent in the transaction record in the Transactions Table 3000 and proceeds to step 533.

In some embodiments, System 160 may maintain the currency units of certain categories of purchases but account for the effects of inflation/deflation (e.g., price variability). For example, one such category may be grocery purchases. In such a case, the System 160 may adjust for price variability. If the System 160 determines in step 512 that a transaction is not subject to unit conversion but the System 160 determines in step 521 that a transaction is subject to adjustment due to price variability in the category (due to the effects of inflation/deflation), the System 160 may convert the transaction base currency amount into an adjusted currency amount in step 524 by dividing the transaction base currency amount by some price index relevant to the date of the transaction. Such a price index may be available from information regularly published by reputable government or industry statistical analysis entities (e.g., U.S. Bureau of Labor Statistics' CPI). The adjusted currency amount may, therefore, accommodate inflationary/deflationary effects. Following the conversion of transaction base currency amount to adjusted currency amount, the System 160 may store the transaction date, user ID, merchant ID, category ID, base currency amount, and adjusted currency amount in the transaction record in the Transactions Table 3000 (step 527) and may proceed to step 533.

If the System 160 determines in step 512 that a transaction is not subject to unit conversion and the System 160 determines in step 521 that a transaction is not subject to adjustment due to price variability in the category, then the System 160 may store the transaction date, user ID, merchant ID, category ID, and base currency amount in the transaction record in the Transactions Table 3000 (step 530) and proceeds to step 533.

If the System 160 determines in step 533 that there are additional transactions in the annual statement file, System 160 may return to step 503 and may begin to process the next transaction in the file. If the System 160 determines in step 533 that there are no additional transactions in the annual statement file, System 160 may proceed to step 536.

This same set of steps may then be repeated for transactions in the monthly statement files as depicted in Steps 536 through 575 except that when the System 160 stores the transactions in steps 554, 563, and 566, the System 160 may overwrite any identical transactions that were stored while processing the annual statement files.

This same set of steps may also be repeated for transactions in the recent activity files as depicted in Steps 575 through 597, except that when the System 160 stores the transactions in steps 587, 593, and 595, the System 160 may overwrite any identical transactions that were stored while processing the annual and monthly statement files. If the System 160 determines in step 597 that there are no more historical transactions to process, it may proceed to step 599 where the process to process historical transactions may be complete.

FIG. 6: Exemplary Process to Calculate Category Baselines

Following the processing of historical transactions 500, the System 160 may proceed to calculate category baselines for purchaser 100 according to the process to calculate category baselines 600. One embodiment of this process is depicted in FIG. 6. Category baselines may represent the volume of purchases purchaser 100 makes in a given category for a specific period preceding the date that they registered with the Service. Category baselines may be used by the System 160 to test for error or gaming conditions as described later, as well as to provide any given purchaser 100 with an understanding of their historical purchase levels in various commerce categories during specific periods. Category baselines may not necessarily be used in the calculations for user rewards or merchant rebates.

In order to accommodate a wide range of normal purchase frequencies across different commerce categories, baseline periods may differ by commerce category. For example, since the purchase frequencies of groceries and gasoline are high relative to other commerce categories, baselines for these categories may be calculated on monthly boundaries. For categories with less relative purchase frequency, baselines may be calculated on quarterly boundaries (e.g., drugstores) or annual boundaries (e.g., home improvement stores) or some other boundary. For simplicity, FIG. 6 assumes all category baselines are calculated using either monthly, quarterly or annual boundaries, but different periods could be used. In step 605, the System 160 may get all historical transactions for a given purchaser 100 in a given category.

If the current category being processed is defined as a monthly category as determined in step 615, the System 160 may calculate the baseline amounts for each of twelve monthly baseline periods in step 635. The baseline periods may be defined as calendar months or alternatively could be defined with some other boundaries as long as the duration of each period equals a month. For example, the baseline periods may each start on the day of the month that purchaser 100 actually registered an account with the Service. The method for calculating the category baselines in step 635 may be a summation of the transaction amounts for each transaction that was executed during a specific baseline period. One alternative approach may account for purchasing pattern aberrations by considering some or all of the transactions occurring in the periods immediately prior to and following the baseline period and using daily averaging to calculate the baseline for the baseline period. In cases where there are less than twelve months of historical transactions available, the System 160 may calculate baselines by extrapolating the historical transaction data that is available adjusted for seasonality for the commerce category based on data as published by a reputable government or industry source (e.g., the U.S. Census Bureau's Monthly and Annual Retail Trade Surveys). For categories that were identified as subject to unit conversion in steps 512, 550, and 583 of process 500, the category baselines may be calculated in step 635 using the volume units amount for each transaction rather than the base currency amount. For categories that were identified as subject to adjustment due to price variability in steps 521, 557, and 589 of process 500, the category baselines may be calculated in step 635 using the adjusted currency amount for each transaction rather than the base currency amount. Following the baseline calculations in step 635, the System 160 may determine (e.g., in step 645) if there are additional categories for which the baselines have not been calculated. If so, the System 160 may return to step 605 to begin processing the next category. If there are no additional categories to process as determined in step 645 the System 160 may proceed to step 660.

If the current category being processed is not defined as a monthly category as determined in step 615, the System 160 may determine (e.g., in step 620) if the category is defined as a quarterly category. If so, the System 160 may calculate the baseline amounts for each of four quarterly baseline periods in step 630. The baseline periods may be defined as calendar quarters or alternatively may be defined with some other boundaries as long as the duration of each period equals one quarter (i.e., 3 months). The method for calculating the category baselines in step 630 may be a simple summation of the transaction amounts for each transaction that was executed during a specific baseline period. One alternative approach may account for purchasing pattern aberrations by considering some or all of the transactions occurring in some portion of the periods immediately prior to and following the baseline period and using daily averaging to calculate the baseline for the current period. In cases where there are less than twelve months of historical transactions available, the System 160 may calculate baselines by extrapolating the historical transaction data that is available adjusted for seasonality for the commerce category based on data as published by a reputable government or industry source (e.g., the U.S. Census Bureau's Monthly and Annual Retail Trade Surveys). For categories that were identified as subject to unit conversion in steps 512, 550, and 583 of process 500, the category baselines may be calculated in step 630 using the volume units amount for each transaction rather than the base currency amount. For categories that were identified as subject to adjustment due to price variability in steps 521, 557, and 589 of process 500, the category baselines may be calculated in step 630 using the adjusted currency amount for each transaction rather than the base currency amount. Following the baseline calculations in step 630 the System 160 may determine in step 645 if there are additional categories for which the baselines have not been calculated. If so, the System 160 may return to step 605 to begin processing the next category. If there are no additional categories to process as determined in step 645 the System 160 may proceed to step 660.

If the current category being processed is not defined as a monthly category as determined in step 615, and is not defined as a quarterly category as determined in step 620, the System 160 may calculate the baseline amounts for a one year baseline period in step 625. The baseline period may be defined as the period beginning exactly one year prior to the date the purchaser 100 registered for the Service and ending on the day preceding the date that the purchaser 100 registered for the Service. The method for calculating the category baselines in step 625 could be a summation of the base currency amounts for each transaction that was executed during that baseline period. For categories that were identified as subject to unit conversion in steps 512, 550 and 583 of process 500, the category baselines may be calculated in step 625 using the volume units amount for each transaction rather than the base currency amount. For categories that were identified as subject to adjustment due to price variability in steps 521, 557 and 589 of process 500, the category baselines may be calculated in step 625 using the adjusted currency amount for each transaction rather than the base currency amount. Following the baseline calculations in step 625 the System 160 may determines (e.g., in step 645) if there are additional categories for which the baselines have not been calculated. If so, the System 160 may return to step 605 to begin processing the next category. If there are no additional categories to process as determined in step 645 the System 160 may proceed to step 660.

Upon completing the calculations of all category baselines, in step 660, the System 160 may store all category baselines for purchaser 100 in the User Baseline Table 2400 and the process for calculating category baselines may be complete as depicted in step 690.

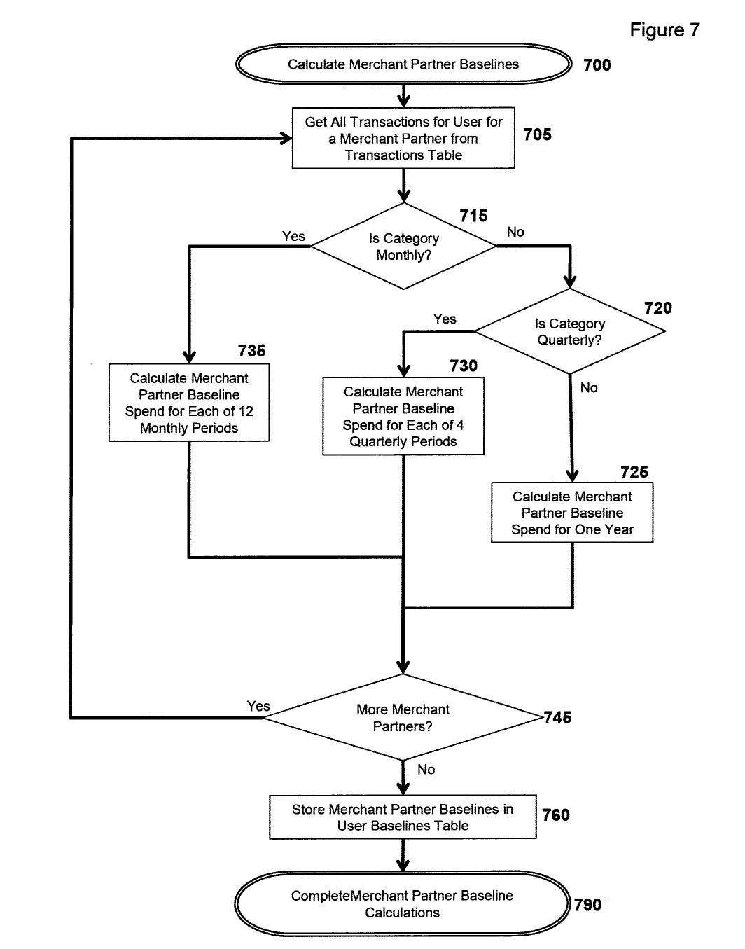

FIG. 7: Exemplary Calculation of Merchant Partner Baselines

Upon completing the process for calculating category baselines 600, the System 160 may begin the process for calculating Merchant Partner baselines 700. One example of this is depicted in FIG. 7. Merchant Partner baselines may represent the volume of purchases purchaser 100 makes at a specific Merchant Partner for a specific baseline period preceding the later of the date that the purchaser 100 registered with the Service or the date that the merchant became a Merchant Partner. The baseline period boundaries may correspond to reward period boundaries for future transactions as described later in this document. Merchant Partner baselines for a given period for purchaser 100 may identify the purchase volume that purchaser 100 must exceed in that period before earning rewards. Any such purchase volume that exceeds the baseline for a given period may be considered Growth Spend and may generate rewards as described later.

In step 705, the System 160 may get all historical transactions from the Transactions Table 3000 for purchaser 100 that were executed at a given Merchant Partner. If the current Merchant Partner being processed is identified as a monthly category Merchant Partner (e.g., as determined in step 715), the System 160 may calculate the Merchant Partner baseline amounts for each of twelve monthly baseline periods in step 735. The baseline period boundaries may correspond to the baseline period boundaries used in the category baseline calculations. Similarly, to calculate Merchant Partner baselines, the System 160 may use any number of methods such as summation, period averaging or extrapolation with seasonality adjustments, so long as it uses the same general method that is used for calculating category baselines. For Merchant Partners assigned to categories that were identified as subject to unit conversion in steps 512, 550, and 583 of process 500, the Merchant Partner baselines may be calculated in step 735 using the volume units amount for each transaction rather than the base currency amount. For Merchant Partners assigned to categories that were identified as subject to adjustment due to price variability in steps 521, 557 and 589 of process 500, the Merchant Partner baselines may be calculated in step 735 using the adjusted currency amount for each transaction rather than the base currency amount. Following the Merchant Partner baseline calculations in step 735, the System 160 may determine in step 745 if there are additional Merchant Partners for which the baselines have not been calculated. If so, the System may return to step 705 to begin processing the next Merchant Partner. If there are no additional Merchant Partners to process as determined in step 745 the System 160 may proceed to step 760.

If the current Merchant Partner being processed is not identified as a monthly category Merchant Partner as determined in step 715, the System 106 may determine in step 720 if the Merchant Partner is identified as a quarterly category Merchant Partner. If so, the System 160 may calculate the Merchant Partner baseline amounts for each of four quarterly baseline periods in step 730. The baseline period boundaries may correspond to the baseline period boundaries used in the category baseline calculations. Similarly, to calculate Merchant Partner baselines, the System 160 may use any number of methods such as simple summation, period averaging, or extrapolation with seasonality adjustments, so long as it uses the same general method that is used for calculating category baselines. For Merchant Partners assigned to categories that were identified as subject to unit conversion in steps 512, 550, and 583 of process 500, the Merchant Partner baselines may be calculated in step 730 using the volume units amount for each transaction rather than the base currency amount. For Merchant Partners assigned to categories that were identified as subject to adjustment due to price variability in steps 521, 557, and 589 of process 500, the Merchant Partner baselines may be calculated in step 730 using the adjusted currency amount for each transaction rather than the base currency amount. Following the Merchant Partner baseline calculations in step 730 the System 160 may determine in step 745 if there are additional Merchant Partners for which the baselines have not been calculated. If so, the System 160 may return to step 705 to begin processing the next Merchant Partner. If there are no additional Merchant Partners to process, as determined in step 745, the System may proceed to step 760.

If the current Merchant Partner being processed is not identified as a monthly category Merchant Partner as determined in step 715, and is not identified as a quarterly category Merchant Partner as determined in step 720, the System 160 may calculate the Merchant Partner baseline amounts for one annual baseline period in step 725. The baseline period boundary may correspond to the baseline period boundary used in the category baseline calculations. Similarly, to calculate Merchant Partner baselines, the System 160 may use any number of methods such as summation or period averaging, so long as it uses the same general method that is used for calculating category baselines. For Merchant Partners assigned to categories that were identified as subject to unit conversion in steps 512, 550, and 583 of process 500, the Merchant Partner baselines may be calculated in step 725 using the volume units amount for each transaction rather than the base currency amount. For Merchant Partners assigned to categories that were identified as subject to adjustment due to price variability in steps 521, 557 and 589 of process 500, the Merchant Partner baselines may be calculated in step 725 using the adjusted currency amount for each transaction rather than the base currency amount. Following the Merchant Partner baseline calculations in step 725 the System 160 may determine in step 745 if there are additional Merchant Partners for which the baselines have not been calculated. If so, the System 160 may return to step 705 to begin processing the next Merchant Partner. If there are no additional Merchant Partners to process as determined in step 745 the System 160 may proceed to step 760.

Once Merchant Partner baselines have been calculated for each Merchant Partner, the System 160 may store, in step 760, the Merchant Partner baselines in the User Baselines Table 2400. The System 160 may proceed to step 790 where the process to calculate Merchant Partner baselines is complete.

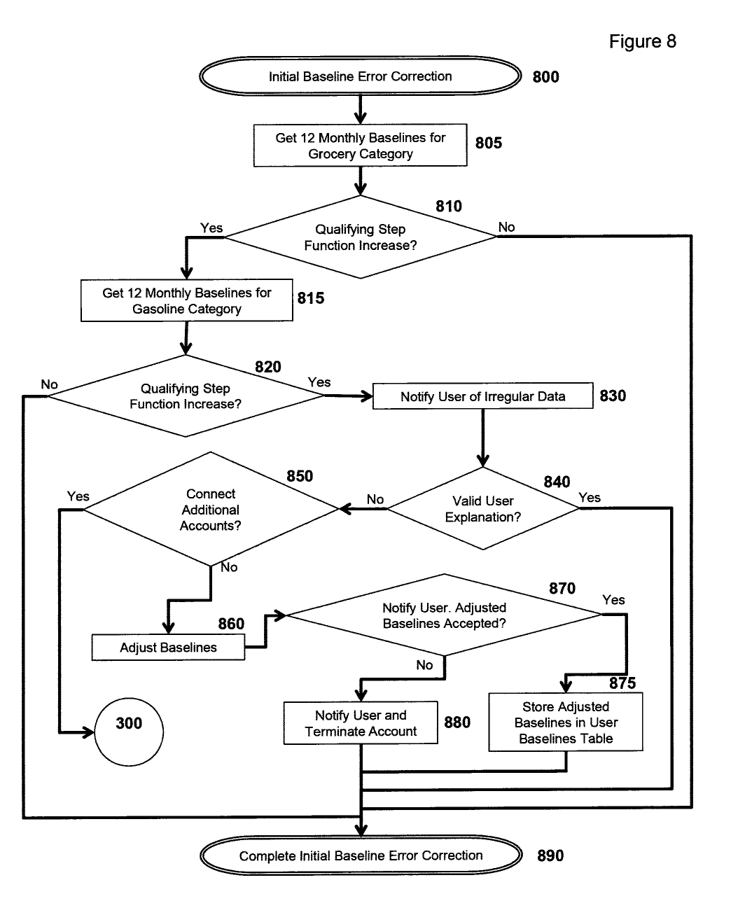

FIGS. 8 and 9: Exemplary Initial Baseline Error Correction

There are a number of conditions that may cause the historical transactional data downloaded by the System 160 to be incomplete, resulting in errors in the baseline calculations. These could include, for example: i) failure by purchaser 100 to connect a Transaction Account to the Service which was actively used at some point in the baseline period but is no longer used; ii) a connected Transaction Account where the Issuer does not provide access to sufficient transactional history; and iii) a purchaser 100 who historically used cash or checks for payment and only began using credit cards, debit cards, or other electronic payment methods for payment sometime during the baseline period. In each of these situations, the category baselines for monthly categories such as groceries and gasoline would show an obvious step-function increase beginning at a certain point in the history and sustained for the duration of the history. An exemplary process of initial baseline error correction 800, as detailed in FIG. 8, corrects for such error conditions.

To identify and adjust for such anomalies, the System 160 may analyzes categories that are defined as monthly categories. In one embodiment, the System 160 may get the twelve monthly baselines for the grocery category for purchaser 100 in step 805 and may evaluate those baselines in step 810 looking for a qualifying step-function increase. To eliminate the effects of naturally occurring spending growth, a qualifying step-function increase may be defined as any step-function increase that begins at a certain point in the twelve-month history and is sustained for the duration of the twelve-month history; and that is sustained for more than the three months of summer (defined as June, July and August in North America); and/or whose magnitude exceeds some minimum threshold (e.g., 20%).

If the System 160 determines in step 810 that there is no qualifying step-function increase in the grocery category baselines, the System 160 may proceed to step 890 where the initial baseline error correction process may be considered to be complete.

If the System 160 identifies a qualifying step-function increase in grocery category baselines in step 810, System 160 may perform a secondary check using the gasoline category. The System 160 may get the twelve monthly baselines for the gasoline category for purchaser 100 in step 815 and evaluates those baselines in step 820 looking for a qualifying step-function increase.

If the System 160 determines in step 820 that there is no qualifying step-function increase in the gasoline category baselines, the System 160 may proceed to step 890 where the initial baseline error correction process may be considered to be complete.

If the System 160 identifies a qualifying step-function increase in gasoline category baselines in step 820, the System 160 may notify purchaser 100 in step 830 of irregular data in the historical transactions and request an explanation from purchaser 100.

If the explanation provided by purchaser 100 is deemed to be valid by the entity administering the Service (“Service Administrator”) in step 840, the System 160 may proceed to step 890 where the initial baseline error correction process is considered to be complete.

If the explanation provided by purchaser 100 is deemed to be invalid by the Service Administrator in step 840, purchaser 100 may be prompted whether they wish to connect additional Transaction Accounts in step 850.

If purchaser 100 indicates a desire to connect additional Transaction Accounts in step 850, the System 160 may return to the process to connect accounts 300 (e.g., as depicted in FIG. 3.) After any additional Transaction Accounts are connected in process 300, the System 160 may repeat the process to acquire historical transactions 400 and the process for processing historical transactions 500 for the newly added Transaction Accounts. Then the System 160 may repeat the process to calculate category baselines 600, the process to calculate Merchant Partner baselines 700 and the initial baseline error correction process 800 using all the transactions for purchaser 100.

If purchaser 100 does not indicate a desire to connect additional Transaction Accounts in step 850, the System 160 may proceed to adjust the category and Merchant Partner baselines using step 860. Any number of methods may be used to adjust the baselines. One such method involves raising those baselines in the periods preceding the qualifying step-function increase by an amount equal to the magnitude of the qualifying step-function increase. An alternative method involves raising those baselines in the periods preceding the qualifying step-function increase by an amount equal to one half of the magnitude of the qualifying step-function increase. Following any adjustment to the purchaser 100's baselines, the System 160 may notify purchaser 100 (in step 870) of the baseline adjustments and prompts purchaser 100 to accept the adjusted baselines in order to continue to use the Service.

If purchaser 100 indicates a desire in step 870 to use the Service with the adjusted baselines, the System 160 may store the adjusted baselines in the User Baseline Table 2400 in step 875 and proceed to step 890 where the initial baseline error correction process may be considered to be complete.

If purchaser 100 chooses in step 870 not to continue to use the Service with the adjusted baselines, the purchaser 100 account may be terminated and purchaser 100 may be notified in step 880 after which the System 160 may proceed to step 890 where the initial baseline error correction may be considered to be complete.

An alternative approach to the Baseline Error Correction process described above may use total spend baselines and transaction count baselines instead of grocery and gasoline category baselines. An example of this approach is shown in FIG. 9.

In step 905 the System 160 may look at all historical transactions for the purchaser 100 and calculates monthly baselines for total spend of all transactions (“Total Spend Baselines”) as well as for the number of transactions in each month (“Transaction Count Baselines”). These baselines may be calculated using the same period averaging techniques used to calculate Merchant Partner baselines for monthly categories.

If the System 160 determines in step 910 that there is no qualifying step-function increase in the Total Spend Baselines, the System 160 may proceed to step 990 where the initial baseline error correction process is considered to be complete.

If the System 160 identifies a qualifying step-function increase in Total Spend Baselines in step 910, System 160 may perform a secondary check using the Transaction Count Baselines. If the System 160 determines in step 920 that there is no qualifying step-function increase in the Transaction Count Baselines, the System 160 may proceed to step 990 where the initial baseline error correction process may be considered to be complete.

If the System 160 identifies a qualifying step-function increase in Transaction Count Baselines in step 920, the System 160 may notify purchaser 100 in step 930 of irregular data in the historical transactions and requests an explanation from the purchaser 100.

If the explanation provided by purchaser 100 is deemed to be valid by the entity administering the Service (“Service Administrator”) in step 940, the System 160 may proceed to step 990 where the initial baseline error correction process is considered to be complete.

If the explanation provided by purchaser 100 is deemed to be invalid by the Service Administrator in step 940, the purchaser 100 may be prompted whether they wish to connect additional Transaction Accounts in step 950.

If purchaser 100 indicates a desire to connect additional Transaction Accounts in step 950, the System 160 may return to the process to connect accounts 300 (e.g., as depicted in FIG. 3). After any additional Transaction Accounts are connected in process 300, the System 160 may repeat the process to acquire historical transactions 400 and the process for processing historical transactions 500 for the newly added Transaction Accounts. Then the System 160 may repeat the process to calculate category baselines 600, the process to calculate Merchant Partner baselines 700 and the initial baseline error correction process 900 using all the transactions for the purchaser 100.

If purchaser 100 does not indicate a desire to connect additional Transaction Accounts in step 950, the System 160 may proceed to adjust the category and Merchant Partner baselines using step 960. Any number of methods may be used to adjust the baselines. One such method involves raising those baselines in the periods preceding the qualifying step-function increase by an amount equal to the magnitude of the qualifying step-function increase. An alternative method involves raising those baselines in the periods preceding the qualifying step-function increase by an amount equal to one half of the magnitude of the qualifying step-function increase. Following any adjustment to the purchaser 100's baselines, the System 160 may notify the purchaser 100 in step 970 of the baseline adjustments and prompt the purchaser 100 to accept the adjusted baselines in order to continue to use the Service.

If purchaser 100 indicates a desire in step 970 to use the Service with the adjusted baselines, the System 160 may store the adjusted baselines in the User Baseline Table 2400 in step 975 and proceed to step 990 where the initial baseline error correction process is considered to be complete.

If purchaser 100 chooses in step 970 not to continue to use the Service with the adjusted baselines, the purchaser 100's account may be terminated and the purchaser 100 may be notified in step 980 after which the System proceeds to step 990 where the initial baseline error correction is considered to be complete.

Acquire On-Going Transactions

Upon completing the initial baseline error correction process 800 (or alternatively 900), the initial set-up for purchaser 100 may be complete. At this point the Service enters a mode of persistent operation for purchaser 100 as depicted, for example, in steps 230, 235, 238, 240, 245, 250 and 260 in FIG. 2. Periodically the System 160 may download all recent transactions for purchaser 100 in step 230. This may occur each time purchaser 100 logs on to the System 160 as well as on some regularly scheduled interval. In step 230, the System 160 may access the account credentials for each Transaction Account for purchaser 100, connects to the Transaction Accounts, and downloads transactions listed under recent activity as well as the most recent monthly statement if available. The monthly statement may be converted and the transactions may be extracted from that statement. This is done with an identical process as is used in steps 405, 410, 420, and 425 of the process to acquire historical transactions 400. The System 160 may remove any duplicate transactions and assign a merchant name and category ID to each transaction. Each transaction may then be processed for volume unit conversion or price variability adjustment as appropriate. The transaction data may then be stored in the Transaction Table 3000. This process may be essentially equivalent to the relevant steps of the process for processing historical transactions 500.

FIG. 10: Exemplary Processing of Rewards/Rebates

Periodically, the System 160 may initiate the processing of user rewards and merchant rebates in step 235. One embodiment provides for a user referral mechanism based on “shared savings,” where a referring user earns additional rewards tied to the rewards earned by a referred user. An example of this process is described in more detail as the process for processing rewards/rebates 1000 as depicted in FIG. 10. The System 160 may calculate all rewards/rebates for a given transaction using either the base currency amount, the volume units amount or the adjusted currency amount as appropriate for the commerce category associated with that transaction. Beginning in step 1003 the process may set a temporary user rewards counter for purchaser 100 to zero. In step 1006, a temporary current spending counter and a temporary merchant rebates counter corresponding to the purchaser 100's spending at a given merchant may each be set to zero. In step 1009, the process may get all transactions for purchaser 100 at a given Merchant Partner for the current reward period from the Transactions Table 3000 provided the transactions have not yet been processed for rewards/rebates. The current reward period may be either a monthly, quarterly or annual period and corresponds to the purchaser 100's baseline period for a given Merchant Partner.

The System 160 may get the first/next transaction in step 1012 and determine in step 1015 if the temporary current period spending is above the merchant baseline for the current reward period.

If the System 160 determines in step 1015 that current spending is above the merchant baseline for the current reward period, the System 160 may proceed to step 1018. If the System 160 determines in step 1015 that current spending is not above the merchant baseline for the current reward period, the System 160 may proceed to step 1036 via step 1033.

If the System 160 determines in step 1018 that the transaction amount is positive, then it may allocate the full transaction amount to growth spend and set the nominal spend amount for that transaction to zero. Growth spend may be defined as that portion of the transaction amount that when added to current spending is above the Merchant Partner baseline for the current reward period. Nominal spend may be defined as that portion of the transaction amount that when added to current spending is at or below the Merchant Partner baseline for the current reward period. The System may proceed to step 1045 via 1030.

If the System 160 determines in step 1018 that the transaction amount is negative (indicating a return transaction) and it determines in step 1021 that the sum of current spending plus the transaction amount is greater than or equal to the merchant baseline, then it may allocate the full transaction amount to growth spend and set the nominal spend amount for that transaction to zero. In this case, the growth spend would be a negative number, effectively reducing prior established user rewards and merchant rebates. The System may then proceed to step 1045 via step 1030.

If the System 160 determines in step 1018 that the transaction amount is negative (indicating a return transaction) and it determines in step 1021 that the sum of current spending plus the transaction amount is less than the merchant baseline, then it may allocate an amount equal to the merchant baseline minus current period spending to growth spend and set the nominal spend amount for that transaction to the transaction amount minus the growth spend. In this case, both the nominal spend and the growth spend would be negative numbers, effectively reducing prior established user rewards and merchant rebates. The System 160 may then proceed to step 1045 via step 1030.

If the System 160 determines in step 1036 that the sum of current period spending plus the transaction amount is less than the merchant baseline, in step 1039, the System 160 may set the nominal spend for that transaction equal to the transaction amount and set the growth spend for that transaction equal to zero. The System 160 may then proceed to step 1045.

If the System 160 determines in step 1036 that the sum of current period spending plus the transaction amount is not less than the merchant baseline, in step 1042, the System 160 may set the growth spend for that transaction equal to the sum of current spending plus the transaction amount minus the merchant baseline. The System 160 may further set the nominal spend for that transaction equal to the transaction amount minus the growth spend for that transaction. The System 160 may then proceed to step 1045.

In step 1045, the System 160 may calculate nominal rewards by multiplying the nominal rewards rate for purchaser 100 for that Merchant Partner as found in the User Rewards Table 2100 by the nominal amount of that transaction. The default nominal rewards rate is zero for all users and for all Merchant Partners, but the System 160 may allow for a non-zero nominal rewards rate should one be warranted. Similarly, the System 160 may calculate the growth rewards by multiplying the growth rewards rate for purchaser 100 for that Merchant Partner as found in the User Rewards Table by the growth amount for that transaction. The System 160 may then proceed to step 1048.

If the System 160 determines in step 1048 that purchaser 100 was not referred by the current Merchant Partner associated with the transaction, then the System 160 may calculate in step 1049 nominal rebates by multiplying the standard nominal rebates rate for purchaser 100 for that Merchant Partner as found in the Merchant Rebates Table 4100 by the nominal amount of that transaction. The default standard nominal rebates rate may be zero for all Merchant Partners, but the System 160 may allow for a non-zero nominal rebates rate should one be warranted. Similarly, the System 160 may calculate the growth rebates by multiplying the standard growth rebates rate for purchaser 100 for that Merchant Partner as found in the Merchant Rebates Table by the growth amount for that transaction. The System 160 may then proceed to step 1051.

If the System 160 determines in step 1048, that purchaser 100 was referred by the current Merchant Partner associated with the transaction, then the System 160 may calculate in step 1050 nominal rebates by multiplying the discounted nominal rebates rate for purchaser 100 for that Merchant Partner as found in the Merchant Rebates Table 4100 by the nominal amount of that transaction. The default discounted nominal rebates rate may be zero for all Merchant Partners, but the System 160 may allow for a non-zero nominal rebates rate should one be warranted. Similarly, the System 160 may calculate the growth rebates by multiplying the discounted growth rebates rate for purchaser 100 for that Merchant Partner as found in the merchant rebates table by the growth amount for that transaction. The discounted rebates rates may effectively provide Merchant Partners with rebate credits for any users they refer to the Service. The System 160 may then proceed to step 1051.

In step 1051, the System 160 may increment the temporary counters. Specifically, current period spending may be incremented by the transaction amount, user rewards may be incremented by the sum of the nominal rewards and growth rewards, and merchant rebates may be incremented by the sum of the nominal rebates and growth rebates. The System 160 may proceed to step 1057 where the transaction is marked as processed, and the Merchant Partner baseline, nominal rewards, growth rewards, nominal rebates and growth rebates may be stored in the transaction record in the Transactions Table 3000. The System 160 may then proceed to step 1060 via step 1057.

If the System 160 determines in step 1060 that purchaser 100 was referred to the Service by another user, the System 160 may proceed to step 1063. Otherwise the System 160 may proceed to step 1072.

If the System 160 determines in step 1063 that the referring user has met certain criteria to qualify for referral credits, the System proceeds to step 1066. Otherwise the System 160 may proceed to step 1072. In step 1066 the System 160 may set referral rewards for the transaction equal to the referral rate as identified in the User Registration Table 2000 times the sum of the nominal rewards plus the growth rewards for the transaction. The referral rewards amount may be stored in the transaction record in the Transactions Table 3000. The System 160 may then proceed to step 969, where the user referral rewards are incremented by the referral rewards for the transaction. The System 160 may then proceed to step 1072.

If the System 160 determines in step 1072 that there are more transactions to be processed from the list of transactions acquired in step 1009, the System 160 may proceed to step 1012 via step 1075 where it gets the next transaction in the list.

If the System 160 determines in step 1072 that there are no further transactions to be processed from the list of transactions acquired in step 1009, the System 160 may proceed to step 1078. In step 1078, the System 160 may add the merchant rebates amount to the Pending Merchant Rebates for that merchant in the Merchant Rebates Table 4100 and proceed to step 1081.

If the System 160 determines in step 1081 that there are additional Merchant Partners for the purchaser 100 for whom transactions have not been processed, the System 160 may proceed to step 1006 via step 1084 and repeat the entire process for the next Merchant Partner.

If the System 160 determines in step 1081 that there are no additional Merchant Partners for the purchaser 100 for whom transactions have not been processed, the System 160 may proceed to step 1087. In step 1087, the System 160 may add the user rewards to the Pending Shopping Rewards for purchaser 100 in the User Rewards Table 2100. The System 160 may then proceed to step 1095 where the process for processing rewards and rebates for purchaser 100 is complete.

Alternative embodiments for processing rewards/rebates could involve calculating rewards and associated rebates using other criteria, such as relative spending growth percentage or growth in share-of-wallet attributed to the Merchant Partners. In all cases, baselines may or may not be adjusted to incorporate purchaser 100's spending patterns after registering for the Service. A determination to adjust baselines would typically be established by the contractual relationship between the System Administrator and the Merchant Partner. Additionally, baselines used to calculate rewards may be adjusted differently than those used to calculate rebates.

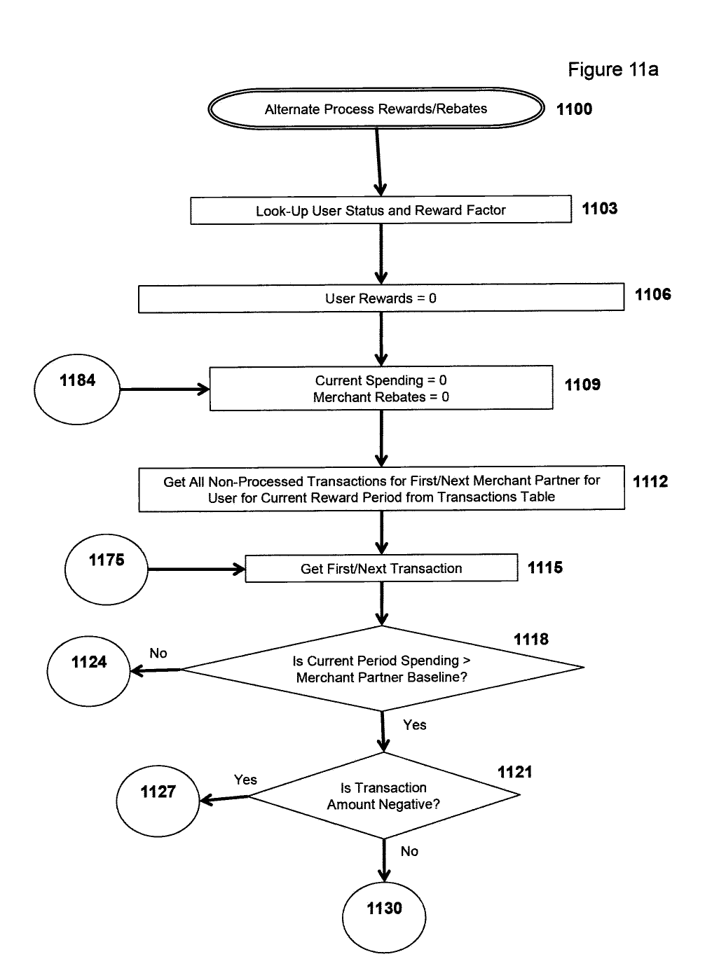

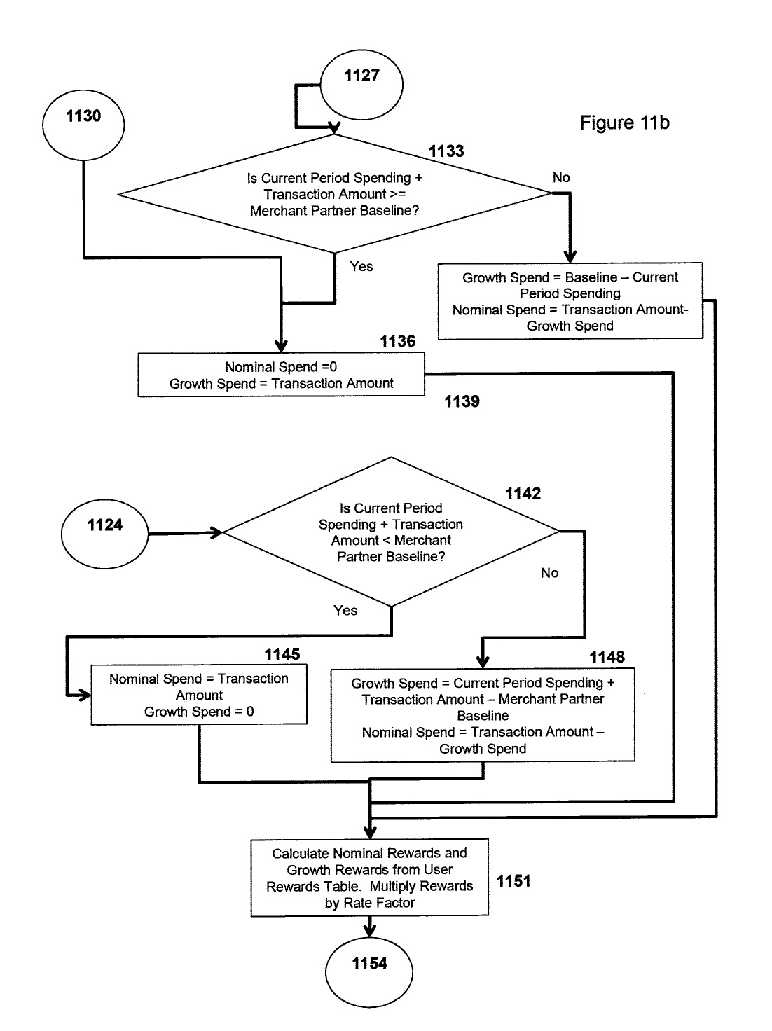

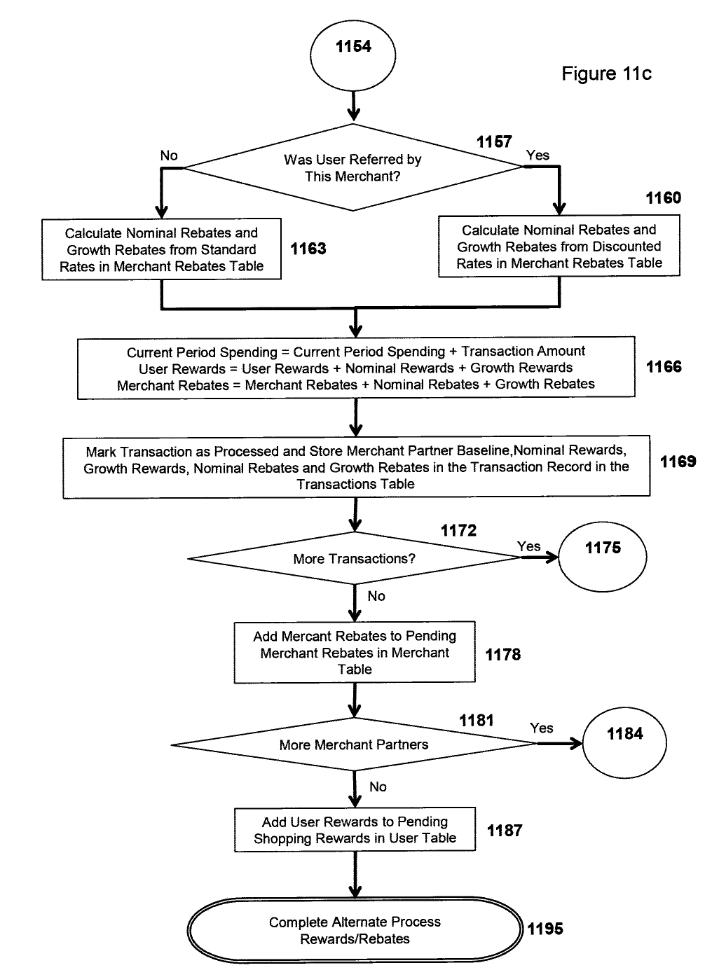

FIG. 11: Exemplary Alternate Process for Rewards/Rebates

In an alternative embodiment, the method for processing user rewards and merchant rebates may provide for a user referral mechanism which increases the rate at which purchaser 100 earns rewards based on purchaser 100's referral activity. An example of this process is described in more detail as the alternate process for processing rewards/rebates 1100 (e.g., as depicted in FIG. 11). The System 160 may calculate all rewards/rebates for a given transaction using either the base currency amount, the volume units amount, or the adjusted currency amount as appropriate for the commerce category associated with that transaction. Beginning in step 1103 the System 160 may look up the User Status (determined by referral activity) in the User Registration Table 2000 and the corresponding Reward Factor from the User Rewards Table 2100. Then in step 1106, the process may set a temporary user rewards counter for purchaser 100 to zero. In step 1109, a temporary current spending counter and a temporary merchant rebates counter corresponding to the purchaser 100's spending at a given merchant may each be set to zero. In step 1112, the process may get all transactions for the purchaser 100 at a given Merchant Partner for the current reward period from the Transactions Table 3000 provided the transactions have not yet been processed for rewards/rebates. The current reward period may either be a monthly, quarterly, or annual period, which may correspond to the purchaser 100's baseline period for a given Merchant Partner.

The System 160 may get the first/next transaction in step 1115 and determine in step 1118 if the temporary current period spending is above the merchant baseline for the current reward period.

If the System 160 determines in step 1118 that current spending is above the merchant baseline for the current reward period, the System 160 may proceed to step 1121. If the System 160 determines in step 1115 that current spending is not above the merchant baseline for the current reward period, the System 160 may proceed to step 1142 via step 1124.

If the System 160 determines in step 1121 that the transaction amount is positive, then it may proceed to step 1136 via step 1130 and allocate the full transaction amount to growth spend and set the nominal spend amount for that transaction to zero. Growth spend may be defined as that portion of the transaction amount that when added to current spending is above the Merchant Partner baseline for the current reward period. Nominal spend may be defined as that portion of the transaction amount that when added to current spending is at or below the Merchant Partner baseline for the current reward period. The System 160 may then proceed to step 1151.

If the System 160 determines in step 1121 that the transaction amount is negative (indicating a return transaction), it may proceed to step 1133 via step 1127. If System 160 determines in step 1133 that the sum of current spending plus the transaction amount is greater than or equal to the merchant baseline, then, in step 1136, it may allocate the full transaction amount to growth spend and set the nominal spend amount for that transaction to zero. In this case, the growth spend would be a negative number, effectively reducing prior established user rewards and merchant rebates. The System 160 may then proceed to step 1151.

If the System 160 determines in step 1121 that the transaction amount is negative (indicating a return transaction) and it determines in step 1133 that the sum of current spending plus the transaction amount is less than the merchant baseline, then it may allocate an amount equal to the merchant baseline minus current period spending to growth spend and set the nominal spend amount for that transaction to the transaction amount minus the growth spend. In this case, both the nominal spend and the growth spend would be negative numbers, effectively reducing prior established user rewards and merchant rebates. The System 160 may then proceed to step 1151.

If the System 160 determines in step 1142 that the sum of current period spending plus the transaction amount is less than the merchant baseline, the System 160 may set, in step 1145, the nominal spend for that transaction equal to the transaction amount and set the growth spend for that transaction equal to zero. The System 160 may then proceed to step 1151.

If the System 160 determines in step 1142 that the sum of current period spending plus the transaction amount is not less than the merchant baseline, the System 160 may set, in step 1148, the growth spend for that transaction equal to the sum of current spending plus the transaction amount minus the merchant baseline. The System 160 may further set the nominal spend for that transaction equal to the transaction amount minus the growth spend for that transaction. The System 160 may then proceed to step 1151.

In step 1151, the System 160 may calculate nominal rewards by multiplying the nominal rewards rate for that user for that Merchant Partner as found in the User Rewards Table 2100 by the nominal amount of that transaction and then by the Rate Factor from step 1103. The default nominal rewards rate may be zero for all users for all Merchant Partners, but the System 160 may allow for a non-zero nominal rewards rate should one be warranted. Similarly, the System 160 may calculate the growth rewards by multiplying the growth rewards rate for purchaser 100 for that Merchant Partner as found in the User Rewards Table by the growth amount for that transaction and then by the Rate Factor. The System 160 may then proceed to step 1157 via step 1154.

If the System 160 determines in step 1157 that purchaser 100 was not referred by the current Merchant Partner associated with the transaction, then the System 160 may calculate, in step 1163, nominal rebates by multiplying the standard nominal rebates rate for purchaser 100 for that Merchant Partner as found in the Merchant Rebates Table 4100 by the nominal amount of that transaction. The default standard nominal rebates rate may be zero for all Merchant Partners, but the System 160 may allow for a non-zero nominal rebates rate should one be warranted. Similarly, the System 160 may calculates the growth rebates by multiplying the standard growth rebates rate for purchaser 100 for that Merchant Partner as found in the Merchant Rebates Table by the growth amount for that transaction. The System 160 may then proceed to step 1166.

If the System 160 determines in step 1157 that the purchaser 100 was referred by the current Merchant Partner associated with the transaction, then the System 160 may calculate, in step 1160, nominal rebates by multiplying the discounted nominal rebates rate for purchaser 100 for that Merchant Partner as found in the Merchant Rebates Table 4100 by the nominal amount of that transaction. The default discounted nominal rebates rate may be zero for all Merchant Partners, but the System 160 may allow for a non-zero nominal rebates rate should one be warranted. Similarly, the System 160 may calculate the growth rebates by multiplying the discounted growth rebates rate for purchaser 100 for that Merchant Partner as found in the merchant rebates table by the growth amount for that transaction. The discounted rebates rates may effectively provide Merchant Partners with rebate credits for any users they refer to the Service. The System 160 may then proceed to step 1166.

In step 1166, the System 160 may then increment the temporary counters. Specifically, current period spending may be incremented by the transaction amount, user rewards may be incremented by the sum of the nominal rewards and growth rewards, and merchant rebates may be incremented by the sum of the nominal rebates and growth rebates. The System 160 may then proceed to step 1169, where the transaction may be marked as processed, and the Merchant Partner baseline, nominal rewards, growth rewards, nominal rebates and growth rebates may be stored in the transaction record in the Transactions Table 3000. The System 160 may then proceed to step 1172.

If the System 160 determines in step 1172 that there are more transactions to be processed from the list of transactions acquired in step 1112, the System 160 may then proceed to step 1115 via step 1175 where it gets the next transaction in the list.

If the System 160 determines in step 1172 that there are no further transactions to be processed from the list of transactions acquired in step 1112, the System proceeds to step 1178. In step 1178 the System 160 may add the merchant rebates amount to the Pending Merchant Rebates for that merchant in the Merchant Rebates Table 4100 and proceed to step 1181.

If the System 160 determines in step 1181 that there are additional Merchant Partners for the purchaser 100 for whom transactions have not been processed, the System 160 may proceed to step 1109 via step 1184 and repeat the entire process for the next Merchant Partner.

If the System 160 determines in step 1081 that there are no additional Merchant Partners for the purchaser 100 for whom transactions have not been processed, the System 160 may proceed to step 1187. In step 1187, the System 160 may add the user rewards to the Pending Shopping Rewards for purchaser 100 in the User Rewards Table 2100. The System 160 may then proceed to step 1195, where the alternate process for processing rewards and rebates for purchaser 100 may be complete.

Alternative embodiments for processing rewards/rebates may involve calculating rewards and associated rebates using other criteria such as relative spending growth percentage or growth in share-of-wallet attributed to the Merchant Partners. In all cases, baselines may or may not be adjusted to incorporate purchaser 100's spending patterns after registering for the Service. A determination to adjust baselines may be established by the contractual relationship between the System Administrator and the Merchant Partner. Additionally, baselines used to calculate rewards may be adjusted differently than those used to calculate rebates.

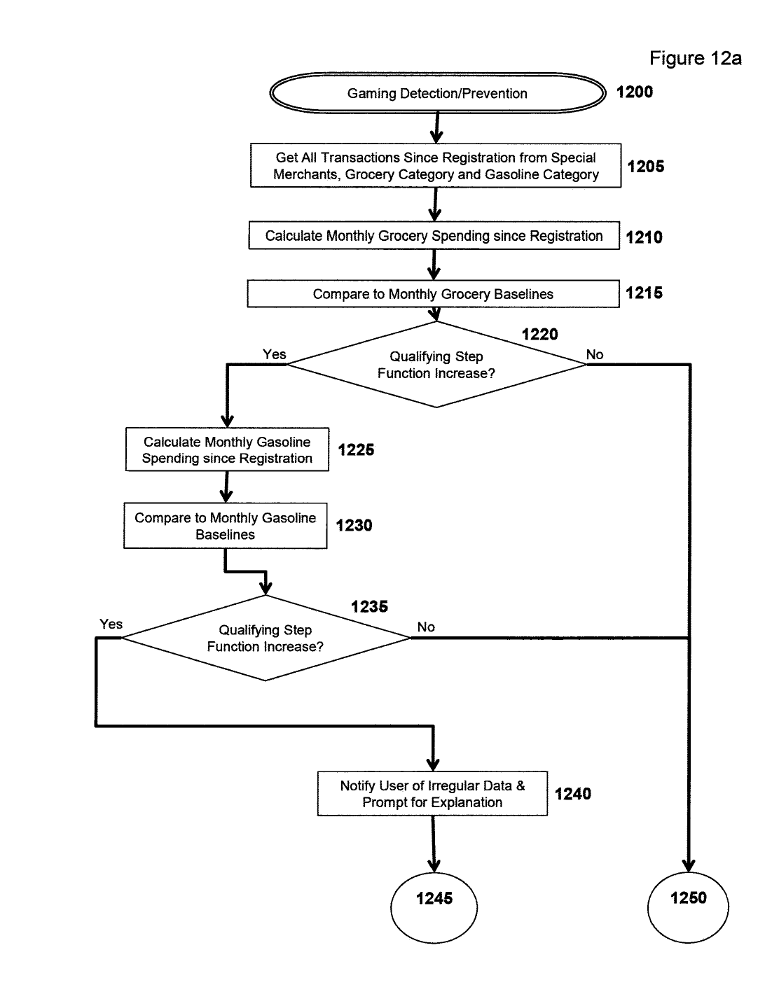

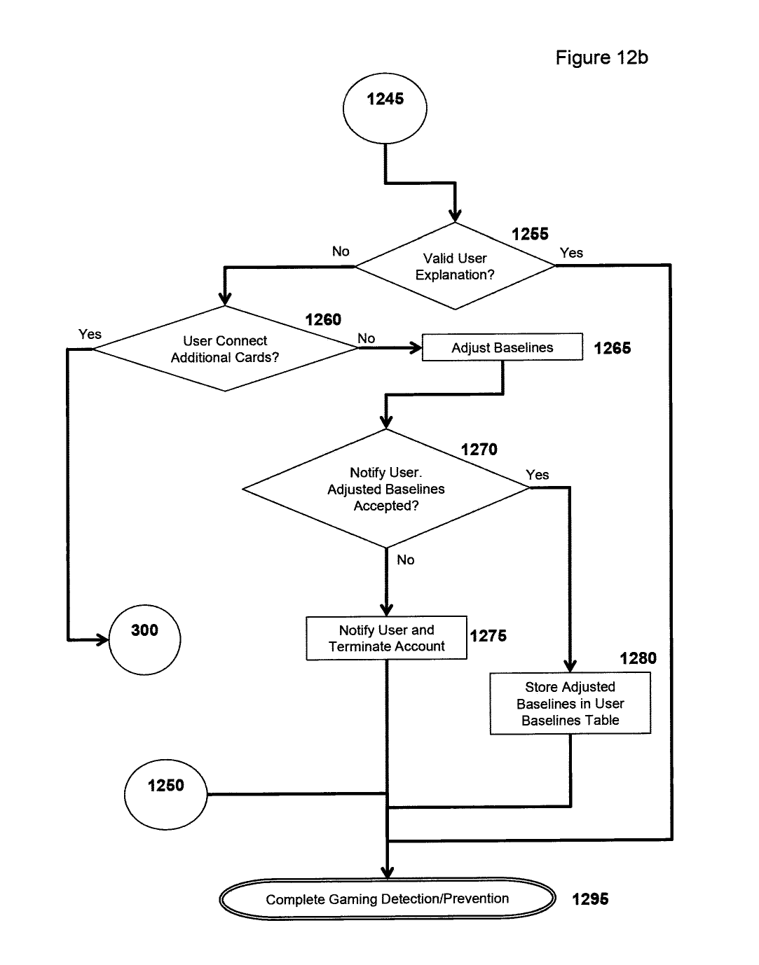

FIG. 12: Exemplary Gaming Detection/Prevention

Registration for the Service should not materially change purchaser 100's aggregate spending patterns. For example, purchaser 100's total grocery spending should not change materially as a result of registering for the Service, although the allocation of that grocery spending across grocery merchants should indeed change. If purchaser 100's total grocery spending as monitored by the Service were to increase materially over purchaser 100's grocery category baselines, that condition may be indicative of a misuse of the Service (e.g., gaming), either intentional or unintentional on the part of purchaser 100. Such a condition may result in purchaser 100 earning excessive and undue rewards and the corresponding Merchant Partners paying excessive and undue rebates. Some of the causes of this gaming condition may include: i) failure by the purchaser 100 to connect a Transaction Account to the Service which was actively used during the baseline period; ii) a purchaser 100 who historically used cash or checks for payment and only began using credit cards, debit cards or other electronic payment methods for payment following registration with the Service; iii) a purchaser 100 increasing on a sustained basis, the amount of cashback received from debit card transactions above their historic levels; and iv) a purchaser 100 increasing on a sustained basis, the amount of gift card purchases above their historical levels. The System 160 may prevent such gaming conditions through the use of the gaming detection/prevention process 1200 (e.g., as depicted in FIG. 12). This process may be invoked on an ad hoc or regular periodic basis for each purchaser 100.

Beginning in step 1205, the System 160 may get all transactions since the date of registration for the Special Merchants, grocery category and gasoline category, from the Transactions Table 3000. In step 1210, the System 160 may calculate monthly grocery spending for purchaser 100 for each monthly reward period since the date that purchaser 100 registered for the Service. The process to calculate the monthly grocery spending may be identical to the process to calculate category baselines 600 except that the calculations may be made on the transactions occurring since the date of registration. In step 1215, the System 160 may compare purchaser 100's monthly grocery spending since registration to the purchaser 100's grocery baselines. If a gaming condition exists, there may be a material step-function increase that began at some point within the three months prior to registration or at any point following registration and is sustained through the current period. To eliminate naturally occurring spending growth, a qualifying step-function increase may have a magnitude that exceeds some minimum threshold (e.g., 20%).

If the System 160 determines in step 1220 that no qualifying step-function increase exists in the grocery spending, it may be deemed that gaming has not occurred, and the System 160 may proceed to step 1295 via step 1250 where the process to detect and prevent gaming may be complete.

If the System 160 determines in step 1220 that a qualifying step-function increase does exist in the grocery spending, it may perform a secondary check using the gasoline category. In step 1225, the System 160 may calculate monthly gasoline spending for purchaser 100 for each monthly reward period since the date that purchaser 100 registered for the Service. The process to calculate the monthly gasoline spending may be identical to the process to calculate category baselines 600 except that the calculations may be made on the transactions occurring since the date of registration. In step 1230, the System 160 may compare purchaser 100's monthly gasoline spending since registration to the purchaser 100's gasoline baselines.

If the System 160 determines in step 1235 that no qualifying step-function increase exists in the gasoline spending, it may be deemed that gaming has not occurred, and the System 160 may proceed to step 1295 via step 1250 where the process to detect and prevent gaming may be complete.

If the System 160 determines in step 1235 that a qualifying step-function increase does exist in the gasoline spending, it may notify purchaser 100 in step 1240 that irregular data exists and prompts purchaser 100 to provide an explanation of the increased spending. The System 160 may then proceed to step 1255 via step 1245.

If purchaser 100's explanation of the increased spending is valid (e.g., as determined in step 1255 by the Service Administrator), it may be deemed that gaming has not occurred, and the System 160 may proceed to step 1295 where the process to detect and prevent gaming is complete.

If purchaser 100's explanation of the increased spending is not valid (e.g., as determined in step 1255 by the Service Administrator), the purchaser 100 may be offered the opportunity to correct the issue by connecting additional Transaction Accounts to the Service.

If purchaser 100 wishes to correct the issue by connecting additional Transaction Accounts to the Service (e.g., as indicated in step 1260), the process for detecting and preventing gaming may be deemed complete and the System 160 may initiate the process to connect Transaction Accounts 300, after which the System 160 may repeat processes 400, 500, and 600, thereby recalculating all baselines for purchaser 100. Following the recalculation of all baselines, the System 160 may reinitiate either process 1000 or 1100 to recalculate rewards and rebates for all transactions since registration.

If purchaser 100 does not wish to correct the issue by connecting additional Transaction Accounts to the Service as indicated in step 1260, the System 160 may automatically adjust purchaser 100's category and merchant baselines in step 1265. Any number of methods may be used to adjust the baselines. One such method involves raising those baselines in the periods preceding the qualifying step-function increase by an amount equal to the magnitude of the qualifying step-function increase. An alternative method involves raising those baselines in the periods preceding the qualifying step-function increase by an amount equal to one half of the magnitude of the qualifying step-function increase. Following any adjustment to the purchaser 100's baselines, the System 160 may notify purchaser 100, in step 1270, of the baseline adjustments and prompts purchaser 100 to accept the adjusted baselines in order to continue to use the Service.

If purchaser 100 indicates a desire in step 1270 to use the Service with the adjusted baselines, the System 160 may store the adjusted baselines in the User Baseline Table 2400 in step 1280 and proceeds to step 1295 where the process to detect and prevent gaming is complete. Following the adjustment of all baselines, the System 160 will reinitiate either process 1000 or 1100 to recalculate rewards and rebates for all transactions since registration.

If purchaser 100 chooses in step 1270 not to continue to use the Service with the adjusted baselines, the purchaser 100 account may be terminated and purchaser 100 may be notified of the termination in step 1275. After termination, the System 160 may proceed to step 1295 where the process to detect and prevent gaming may be complete.

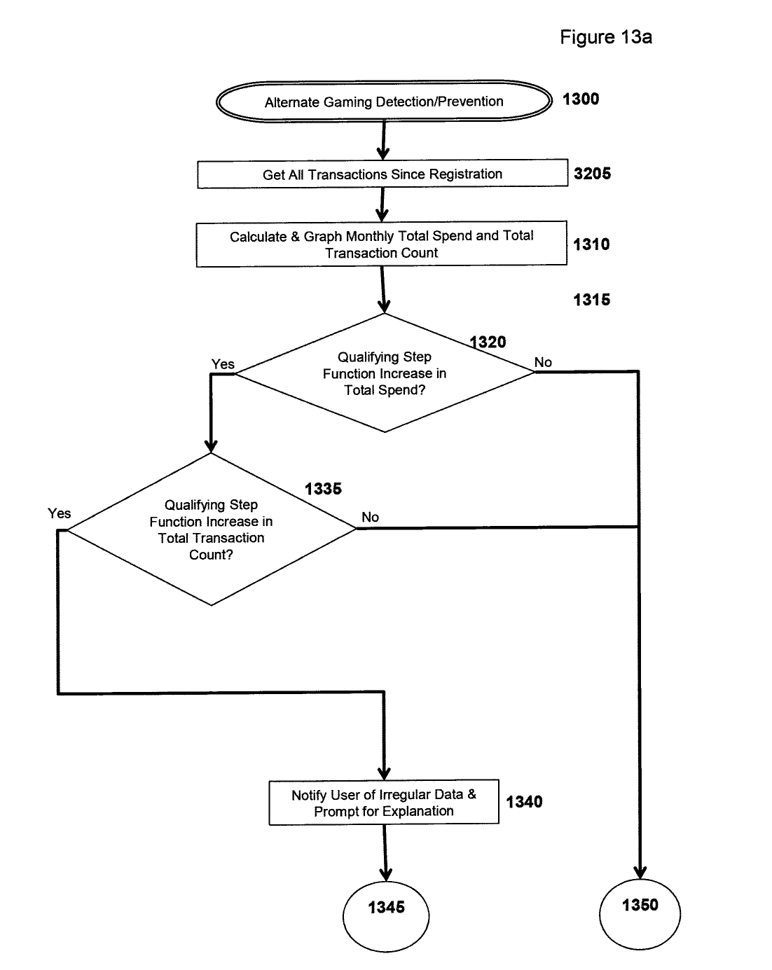

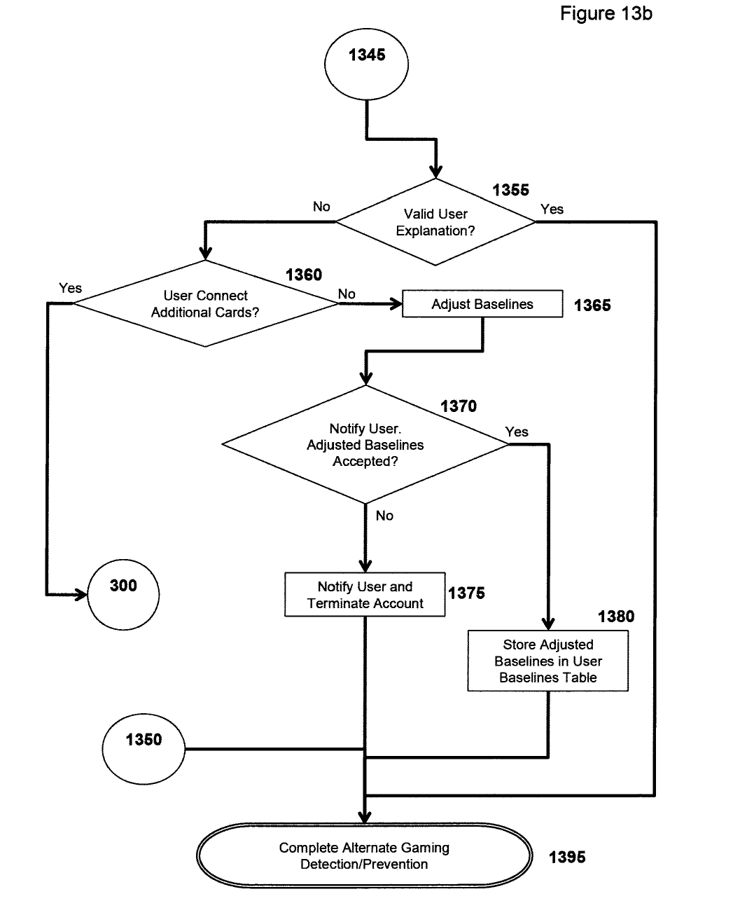

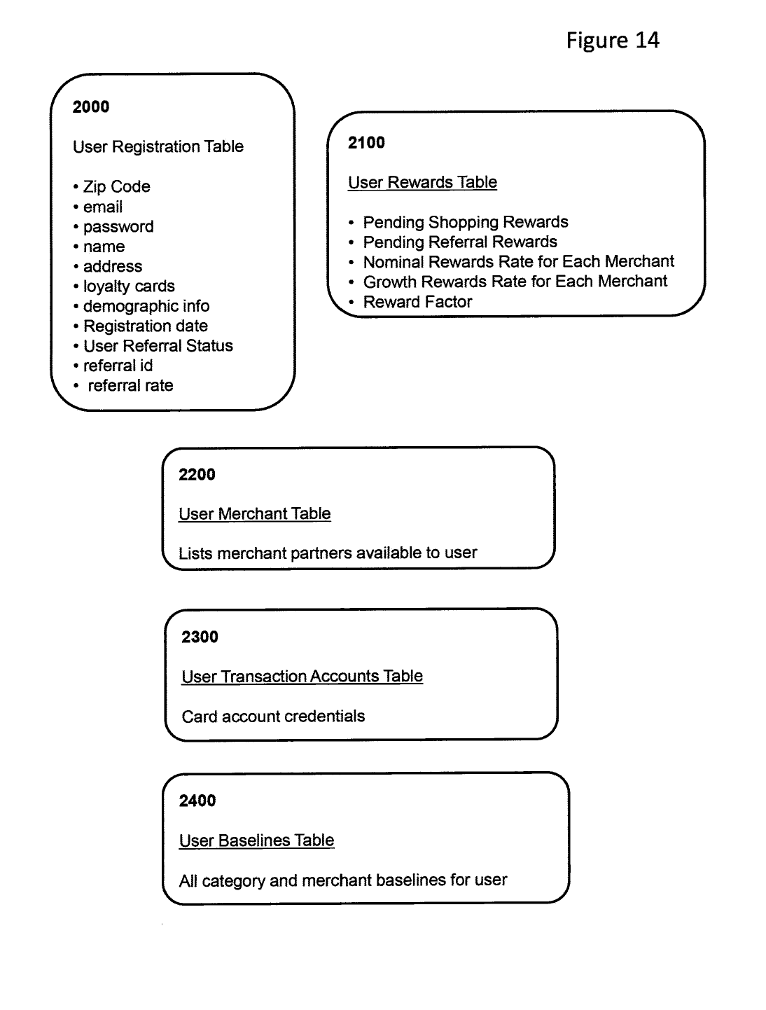

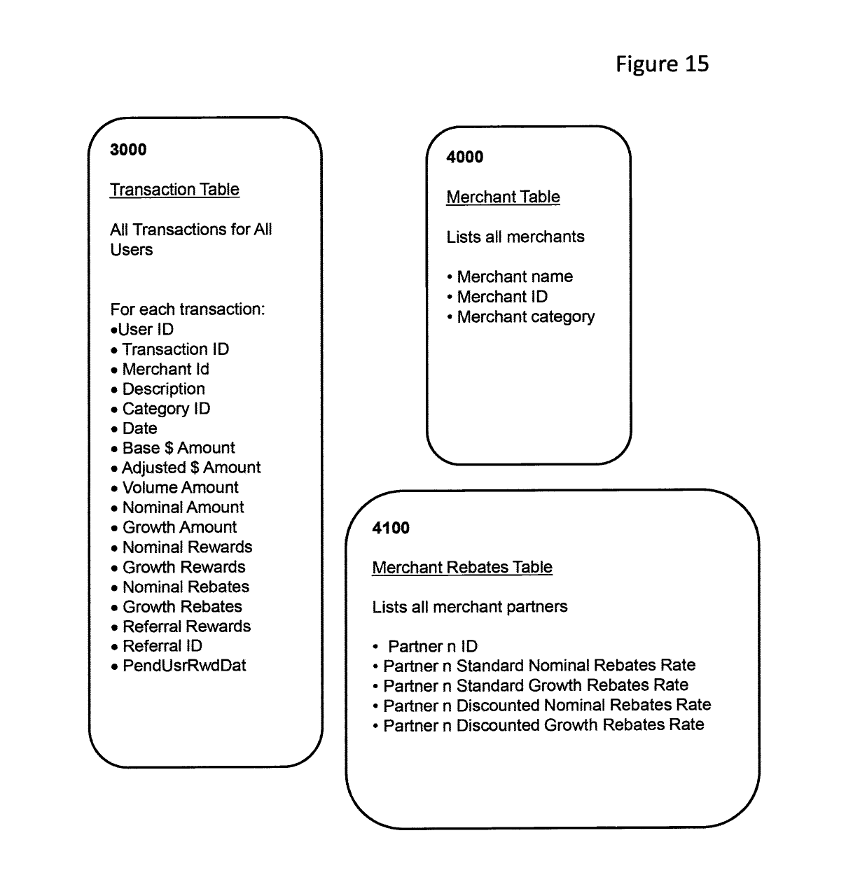

FIG. 13: Alternate Exemplary Gaming Detection/Prevention

An alternative approach to detect gaming could analyze aggregate spending patterns rather than spending within certain commerce categories. An example of such an approach is described below and depicted in FIG. 13. This process may be invoked on a periodic basis but at least monthly for each user.

Beginning in step 1305, the System 160 may get all transactions for purchaser 100 from the Transactions Table 3000. In step 1310, the System 160 may calculate monthly total spending and monthly total transaction count for purchaser 100. The method to do this calculation may be a summation or embodiment may do some level of filtering/averaging to discount purchase pattern aberrations. The System 160 may then analyze this data to determine if either the total spend or the total transaction count has materially changed over time. If a gaming condition exists, there may be a material step-function increase that began at some point within the three months prior to registration or at any point following registration and is sustained through the current period. To eliminate naturally occurring spending growth, a qualifying step-function increase may have a magnitude that exceeds some minimum threshold (e.g., 20%).

If the System 160 determines in step 1320 that no qualifying step-function increase exists in the total spend calculations, it may be deemed that gaming has not occurred, and the System 160 may proceed to step 1395 via step 1350 where the process to detect and prevent gaming is complete.

If the System 160 determines in step 1320 that a qualifying step-function increase does exist in the total spend calculations, it may perform a secondary check using the total transaction count calculations. If the System 160 determines in step 1335 that no qualifying step-function increase exists in the total transaction count calculations, it may be deemed that gaming has not occurred, and the System 160 may proceed to step 1395 via step 1350 where the process to detect and prevent gaming may be complete.

If the System 160 determines in step 1335 that a qualifying step-function increase does exist in the total transaction count calculations, it may notify purchaser 100 in step 1340 that irregular data exists and prompts purchaser 100 to provide an explanation of the increased spending. The System 160 may then proceed to step 1355 via step 1345.

If purchaser 100's explanation of the increased spending is valid (e.g., as determined in step 1355 by the Service Administrator), it may be deemed that gaming has not occurred, and the System 160 may proceed to step 1395 where the process to detect and prevent gaming is complete.

If purchaser 100's explanation of the increased spending is not valid (e.g., as determined in step 1355 by the Service Administrator), the purchaser 100 may be offered the opportunity to correct the issue by connecting additional Transaction Accounts to the Service.

If purchaser 100 wishes to correct the issue by connecting additional Transaction Accounts to the Service, as indicated in step 1360, the process for detecting and preventing gaming may be deemed complete and the System 160 may initiate the process to connect Transaction Accounts 300 after which the System 160 may repeat processes 400, 500 and 600 thereby recalculating all baselines for purchaser 100. Following the recalculation of all baselines, the System 160 may reinitiate either process 1000 or 1100 to recalculate rewards and rebates for all transactions since registration.

If the purchaser 100 does not wish to correct the issue by connecting additional Transaction Accounts to the Service, as indicated in step 1360, the System 160 may automatically adjust purchaser 100's category and merchant baselines in step 1365. Any number of methods may be used to adjust the baselines. One such method involves raising those baselines in the periods preceding the qualifying step-function increase by an amount equal to the magnitude of the qualifying step-function increase. Following any adjustment to purchaser 100's baselines, the System 160 may notify purchaser 100, in step 1370, of the baseline adjustments and prompt purchaser 100 to accept the adjusted baselines in order to continue to use the Service.

If purchaser 100 indicates a desire in step 1370 to use the Service with the adjusted baselines, the System 160 may store the adjusted baselines in the User Baseline Table 2400 in step 1380 and proceed to step 1395 where the process to detect and prevent gaming may be complete. Following the adjustment of all baselines, the System 160 may reinitiate either process 1000 or 1100 to recalculate rewards and rebates for all transactions since registration.

If purchaser 100 chooses in step 1370 not to continue to use the Service with the adjusted baselines, purchaser 100's account may be terminated and purchaser 100 may be notified in step 1375. After termination, the System 160 may proceed to step 1395 where the process to detect and prevent gaming may be complete.

### Exemplary User Communications & Dashboard

The System 160 may provide users with a number of methods to monitor spending patterns, transactions, rewards, referral activity and other noteworthy items. One of these methods may include a user-specific dashboard available to purchaser 100 upon logging-in to the System via the System website. The dashboard may provide visual or textual representations of information including but not limited to: i) purchaser 100's current period spending for each Merchant Partner in relation to the appropriate spending baselines; ii) purchaser 100's recently earned spending rewards; iii) purchaser 100's recent spending patterns organized by commerce category; iv) purchaser 100's recent transactions; v) purchaser 100's recently earned referral rewards; vi) purchaser 100's cumulative rewards pending redemption; vi) purchaser 100's referral activity; vii) notice or alerts about new Merchant Partners; vii) notes or alerts about System maintenance; etc. Another communication method may include email and/or text notifications providing similar information to the dashboard or alternatively providing a prompt for purchaser 100 to check their dashboard and a link to that dashboard.

### Exemplary User Referral Tools

The System 160 may provide users with a tool to expose the System to other prospective users via email or more contemporary social network technologies.

The foregoing description has been presented for purposes of illustration. It is not exhaustive and is not limiting to the precise forms or embodiments disclosed. Modifications and adaptations will be apparent to those skilled in the art from consideration of the specification and practice of the disclosed embodiments.

The claims are to be interpreted broadly based on the language employed in the claims and not limited to examples described in the present specification, which examples are to be construed as non-exclusive. Further, the steps of the disclosed methods may be modified in any manner, including by reordering steps and/or inserting or deleting steps.

It is intended, therefore, that the specification and examples be considered as exemplary only. Additional embodiments are within the purview of the present disclosure and claims.

We claim:

1. A computer-implemented method for rewarding a purchaser for increasing their purchase volume with at least one participating merchant, the method comprising:
offering an incentive for the purchaser to increase their purchase volume with the participating merchant;
obtaining a first set of electronic transactions between the purchaser and the participating merchant;
determining a merchant baseline for the purchaser based on the first set of electronic transactions;
obtaining a second set of electronic transactions between the purchaser and the participating merchant;
comparing the second set of electronic transactions to the merchant baseline; and
providing the reward to the purchaser based on the comparison.

2. The computer-implemented method of claim 1, wherein the incentive is based on an agreement for the participating merchant to pay rebates to an administrator of a service for increased spending levels above the baseline by the purchaser at the participant merchant.

3. The computer-implemented method of claim 1, further comprising calculating category baselines that represent the purchaser's historical spending levels for certain periods in various commerce categories.

4. The computer-implemented method of claim 1, wherein the merchant baseline represents the purchaser's historical spending levels for certain periods at the merchant.

5. The computer-implemented method of claim 4, further comprising detecting and correcting for missing historical transactional data.

6. The computer-implemented method of claim 1, further comprising detecting and preventing purchaser gaming.

7. The computer-implemented method of claim 1, wherein comparing the second set of electronic transactions to the merchant baseline accounts for price variability.

8. The computer-implemented method of claim 1, wherein comparing the second set of electronic transactions to the merchant baseline comprises converting from a currency to a unit volume.

9. The computer-implemented method of claim 1, further comprising adjusting the merchant baseline to account for recent purchase activity.

10. A system for rewarding a purchaser for increasing their purchase volume with at least one participating merchant, the system comprising:
a storage medium storing a set of instructions; and
at least one processor for executing the set of instructions to perform a method comprising:
offering an incentive for the purchaser to increase their purchase volume with the participating merchant;
obtaining a first set of electronic transactions between the purchaser and the participating merchant;
determining a merchant baseline for the purchaser based on the first set of electronic transactions;
obtaining a second set of electronic transactions between the purchaser and the participating merchant;
comparing the second set of electronic transactions to the merchant baseline; and
providing the reward to the purchaser based on the comparison.

11. The system of claim 10, wherein the incentive is based on an agreement for the participating merchant to pay rebates to an administrator of a service for increased spending levels above the baseline by the purchaser at the participant merchant.

12. The system of claim 10, the method further comprising calculating category baselines that represent the purchaser's historical spending levels for certain periods in various commerce categories.

13. The system of claim 10, wherein the merchant baseline represents the purchaser's historical spending levels for certain periods at the merchant.

14. The system of claim 10, the method further comprising detecting and correcting for missing historical transactional data.

15. The system of claim 10, the method further comprising detecting and preventing purchaser gaming.

16. The system of claim 10, wherein comparing the second set of electronic transactions to the merchant baseline accounts for price variability.

17. The system of claim 10, wherein comparing the second set of electronic transactions to the merchant baseline comprises converting from a currency to a unit volume.

18. The system of claim 10, the method further comprising adjusting the merchant baseline to account for recent purchase activity.

19. A non-transitory computer-readable medium storing a set of instructions, which when executed by a processor, perform a method for rewarding a purchaser for increasing their purchase volume with at least one participating merchant, the method comprising:
offering an incentive for the purchaser to increase their purchase volume with the participating merchant;
obtaining a first set of electronic transactions between the purchaser and the participating merchant;
determining a merchant baseline for the purchaser based on the first set of electronic transactions;
obtaining a second set of electronic transactions between the purchaser and the participating merchant;
comparing the second set of electronic transactions to the merchant baseline; and
providing the reward to the purchaser based on the comparison.

20. The non-transitory computer-readable medium of claim 19, the method further comprising calculating category baselines that represent the purchaser's historical spending levels for certain periods in various commerce categories.
